(19) United States
(12) Patent Application Publication
(10) Pub. No.: US 2007/0214073 A1
(43) Pub. Date: Sep. 13, 2007

(54) FACILITATOR ARRANGEMENT, METHOD AND COMPUTER PROGRAM PRODUCT FOR MANAGING A REAL-ESTATE PORTFOLIO

(76) Inventor: Jeffrey C. Smith, Fairhope, AL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/748,982

(22) Filed: May 15, 2007

Related U.S. Application Data
(63) Continuation-in-part of application No. 11/556,280, filed on Nov. 3, 2006.
(63) Continuation-in-part of application No. 11/556,292, filed on Nov. 3, 2006.
Application No. 11/556,292 is a continuation of application No. 10/890,548, filed on Jul. 13, 2004, now Pat. No. 7,152,037.
(60) Provisional application No. 60/747,352, filed on May 16, 2006.
(60) Provisional application No. 60/565,554, filed on Apr. 27, 2004.

(51) Int. Cl. G06Q 40/00

(52) U.S. Cl. 705/36 R

(57) ABSTRACT

A method includes receiving, and storing in a computer-readable storage medium, asset base criteria for one or more properties of a participant, where the asset base criteria characterizes the respective one or more properties of the participant. Acquisition criteria for one or more properties one or more other participants anticipate purchasing are also received and stored in a computer-readable medium, where the acquisition criteria characterize the respective one or more properties the one or more other participants anticipating purchasing. The method also includes providing, to the participant, a number of properties the one or more other participants anticipate purchasing that have acquisition criteria matching the asset base criteria of the respective one or more properties of the participant. In this regard, the number of properties is provided for display as a measure of demand for the one or more properties of the participant.

### CROSS-REFERENCE TO RELATED APPLICATIONS

The present application claims priority from U.S. Provisional Patent Application No. 60/747,352, entitled: System, Method and Computer Program Product for Facilitating Real Estate Transactions, filed May 16, 2006; is a continuation-in-part of U.S. patent application Ser. No. 11/556,280, entitled: System, Method and Computer Program Product for Facilitating a Real Estate Exchange, filed Nov. 3, 2006; and is a continuation-in-part of U.S. patent application Ser. No. 11/556,292, entitled: System, Method and Computer Program Product for Facilitating Real Estate Transactions, filed Nov. 3, 2006, which is a continuation of U.S. Pat. No. 7,152,037, entitled: System, Method and Computer Program Product for Facilitating Real Estate Transactions, issued Dec. 19, 2006, which claims priority from U.S. Provisional Patent Application No. 60/565,554, entitled: System, Method and Computer Program Product for Facilitating Real Estate Transactions, filed on Apr. 27, 2004, the contents of all of which are incorporated herein by reference in their entireties.

### FIELD OF THE INVENTION

The present invention generally relates to systems and methods for facilitating real estate transactions and, more particularly, relates to systems, methods and computer program products for providing real-time demand and/or valuation for properties to thereby facilitate real estate transactions involving those properties.

### BACKGROUND OF THE INVENTION

In the commercial real estate industry, potential sellers of commercial real estate often avoid publicly advertising or listing their real estate, and potential sellers and buyers are often very cautious about selling or purchasing commercial real estate that has single or multiple existing tenants. Potential sellers often fear that existing tenants of affected properties will look to lease space elsewhere, and/or that potential tenants will avoid leasing space within the affected properties. Potential buyers, on the other hand, are typically reluctant to purchase property due to the risk of default of tenants leasing space within the property.

In addition, potential sellers typically prefer to not be “shopped” by competitors, or felt out by numerous developers and/or potential buyers. Further, potential sellers typically prefer to not be limited by listing agreements or agency relationships that bind the potential sellers to a single brokerage firm or an unnecessary agency liability for a specific duration. And as a result of potential sellers avoiding public advertising or listing of their properties, in various segments of commercial real estate, the demand of available potential buyers may significantly outnumber the supply of known, publicly available properties. However, this generally does not reflect the fact that the demand of available potential buyers significantly outnumbers the supply of properties available for purchase, only that a significant number of available properties may not be publicly available, and thus known to potential buyers.

### SUMMARY OF THE INVENTION

In light of the foregoing background, exemplary embodiments of the present invention provide an improved system, method and computer program product for facilitating real estate transactions. According to one aspect of exemplary embodiments of the present invention, a method is provided that includes receiving, and storing in a computer-readable storage medium, asset base criteria for one or more properties of a participant, where the asset base criteria characterizes the respective one or more properties of the participant. Acquisition criteria for one or more properties one or more other participants anticipate purchasing (anticipate or otherwise desire to purchase) are also received and stored in a computer-readable medium, where the acquisition criteria characterizes the respective one or more properties the one or more other participants anticipating purchasing. The method also includes providing to the participant, in real time or otherwise, a number of properties the one or more other participants anticipate purchasing that have acquisition criteria matching the asset base criteria of the respective one or more properties of the participant. In this regard, the number of properties is provided for display by the participant, where the number of properties is displayed as a measure of demand for the one or more properties of the participant.

The method may also include receiving asset base criteria for one or more properties of one or more other participants, and providing to the participant, in real time or otherwise, a second number of properties of one or more other participants that have asset base criteria matching the asset base criteria of the respective one or more properties of the participant. In such instances, the second number of properties may be provided for display by the participant, where the second number of properties is displayed as a measure of supply of one or more properties.

In addition, the method may include receiving an adjustment of the asset base criteria for a property of the participant, where providing the number of properties includes updating, in real time or otherwise, the number of properties provided to the participant. In such instances, the asset base criteria may include a plurality of criteria selected from the group consisting of property type, region, price range and capitalization rate.

According to another aspect of exemplary embodiments of the present invention, a method is provided that includes maintaining a database including information associated with a real-estate portfolio of a participant, where the real-estate portfolio includes a plurality of properties of the participate, and the properties are initially in a hold state in the database. The method also includes receiving selection of a property in the portfolio for offering the respective property for sale; and moving the selected property from the hold state to a for-sale state, including automatically notifying one or more other participants of the respective property being offered for sale. After moving the selected property, the real-estate portfolio includes at least the selected property in the for-sale state, and one or more other properties in the hold state.

The method may also include providing to the participant, a home page including the respective real-estate portfolio, where the home page is provided for display by the participant to manage the respective real-estate portfolio. In such instances, the home page includes a portion identifying one or more properties of the respective portfolio in the hold state, and a portion identifying one or more properties of the respective portfolio in the for-sale state. Also in such instances, the property selection may be received via the home page.

In addition, the method may include notifying the participant of one or more properties of one or more other participants being offered for sale. In such instances, the participant may be automatically notified in response to (a) receiving selection of one or more properties in the hold state, and (b) moving the respective one or more properties from the hold state to the for-sale state. Further, in instances also including providing the home page, the home page may further include a portion identifying one or more properties of one or more other participants in the for-sale state. Thus, the participant may be notified of the properties of other participant(s) via the home page.

Further, the method may include receiving, from another participant, selection of a property of the participant in the for-sale state, where the respective property is a for-sale property of the participant. Then, in response thereto, the method may include moving the selected for-sale property from the for-sale state to an engaged state at least partially in response to receiving selection of the for-sale property; engaging, for an engagement period, the participant and the other participant in communication regarding the selected for-sale property. Communication between one or both of the participant and the other participant and further participants may then be restricted during the engagement period. In this regard, restricting communication may include restricting further participants from accessing or removing, from information available to further participants, at least some information for the selected for-sale property.

As indicated above and explained in greater detail below, the system, method and computer program product of exemplary embodiments of the present invention may solve the problems identified by prior techniques and may provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for facilitating real estate transactions in accordance with exemplary embodiments of the present invention;

FIG. 2 is a schematic block diagram of an entity capable of operating as a buyer, seller and/or facilitator, in accordance with exemplary embodiments of the present invention;

FIGS. 3A and 3B are flowcharts illustrating various steps in a method of facilitating a real estate transaction in accordance with an exemplary embodiment of the present invention;

FIG. 4 is a flowchart illustrating various steps in a method of insuring the owner or leaseholder of income-producing property against the default of one or more tenants of such property, in accordance with an exemplary embodiment of the present invention; and

FIGS. 5-32 illustrate exemplary displays capable of being provided by a facilitator arrangement to buyer arrangements and seller arrangements, in accordance with embodiments of the present invention.

### DETAILED DESCRIPTION OF THE INVENTION

The present invention now will be described more fully hereinafter with reference to the accompanying drawings, in which preferred exemplary embodiments of the invention are shown. This invention may, however, be embodied in many different forms and should not be construed as limited to the exemplary embodiments set forth herein; rather, these exemplary embodiments are provided so that this disclosure will be thorough and complete, and will fully convey the scope of the invention to those skilled in the art. Like numbers refer to like elements throughout.

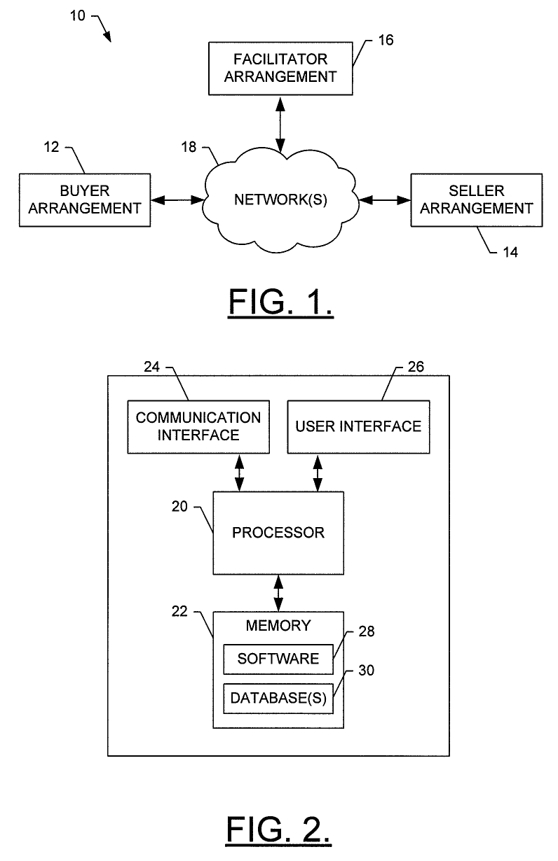

Referring to FIG. 1, a system 10 for facilitating real estate transactions includes one or more buyer arrangements 12, seller arrangements 14 and facilitator arrangements 16 (one of each being shown). Each buyer arrangement is capable of directly and/or indirectly communicating with one or more seller arrangements and facilitator arrangements. Similarly, each seller arrangement is capable of directly and/or indirectly communicating with one or more buyer arrangements and facilitator arrangements; and each facilitator arrangement is capable of directly and/or indirectly communicating with one or more buyer arrangements and seller arrangements. In this regard, the buyer, seller and facilitator arrangements can be capable of directly and/or indirectly communicating with one another across one or more networks 18. The network(s) can comprise any of a number of different combinations of one or more different types of networks. For example, the network(s) can include one or more data networks, such as a local area network (LAN), a metropolitan area network (MAN), and/or a wide area network (WAN) (e.g., Internet), and include one or more wireline and/or wireless voice networks, including a wireline network such as a public-switched telephone network (PSTN), and/or wireless networks such as IS-136 (TDMA), GSM, and/or IS-95 (CDMA). For purposes of illustration, however, as described below, the network comprises the Internet (i.e., WAN) unless otherwise noted.

The buyer arrangement 12, seller arrangement 14 and facilitator arrangement 16 can comprise any one or more of a number of different entities, devices or the like capable of operating in accordance with exemplary embodiments of the present invention. In this regard, one or more of the buyer arrangement, seller arrangement and facilitator arrangement can comprise, include or be embodied in one or more processing elements, such as one or more of a laptop computer, desktop computer, server computer or the like. Additionally or alternatively, one or more of the buyer arrangement, seller arrangement and facilitator arrangement can comprise, include or be embodied in one or more portable electronic devices, such as one or more of a mobile telephone, portable digital assistant (PDA), pager or the like. For example, the buyer arrangement, seller arrangement and facilitator arrangement can each comprise a processing element capable of communicating with one another across the Internet (e.g., network 18).

It should be understood, however, that one or more of the buyer arrangement 12, seller arrangement 14 and facilitator arrangement 16 can comprise or otherwise be associated with a user carrying out the functions of the respective entity. For example, the buyer arrangement can comprise a buyer or buyer agent (representing a buyer) communicating across a PSTN (e.g., network 18), by mail or in person with a seller operating a seller processing element, where the seller and processing element collectively comprise the seller arrangement. In such instances, the facilitator arrangement can comprise a facilitator processing element communicating across the Internet with the seller processing element. Alternatively, in such instances, the facilitator can comprise a facilitator operating a facilitator processing element, where the facilitator is capable of communicating with the seller across a PSTN. As explained below, then, the term “buyer arrangement” can refer to a buyer and/or buyer processor. Similarly, the term “seller arrangement” can refer to a seller and/or seller processor; and the term “facilitator arrangement” can refer to a facilitator and/or facilitator processor.

Referring now to FIG. 2, a block diagram of an entity capable of operating as a buyer arrangement 10, seller arrangement 14 and/or facilitator arrangement 16 is shown in accordance with one exemplary embodiment of the present invention. Although shown as separate entities, in some exemplary embodiments, one or more entities may support one or more of a buyer arrangement, seller arrangement and/or facilitator arrangement, logically separated but co-located within the entit(ies). For example, a single entity may support a logically separate, but co-located, buyer arrangement and facilitator arrangement. Also, for example, a single entity may support a logically separate, but co-located seller arrangement and facilitator arrangement. As shown, the entity capable of operating as a buyer arrangement 12, seller arrangement 14 and/or facilitator arrangement 16 can generally include a processor 20 connected to a memory 22. The processor can also be connected to at least one communication interface 24 or other means for transmitting and/or receiving data, content or the like. The processor can additionally be connected to a user interface 26 that can include a display and a user input interface. The user input interface, in turn, can comprise any of a number of devices allowing the entity to receive data from a user, such as a keypad, a touch display (not shown) or other input device.

The memory 30 can comprise volatile and/or non-volatile memory, and typically stores content, data or the like. In this regard, the memory typically stores software applications 28, instructions or the like for the processor to perform steps associated with operation of the entity in accordance with exemplary embodiments of the present invention. For example, the memory can store software applications such as one or more connectivity applications (e.g., Web browser, etc.). Also, when the entity comprises a facilitator arrangement 16, the memory can store one or more databases 38, such as a buyer database and a property database. The buyer database can store information relating to buyers registered with the service offered by the facilitator arrangement, and the property database can store information relating to sellers and associated properties that are registered with the service. As explained herein, buyers and sellers may individually or collectively be referred to as participants of the service offered by the facilitator arrangement. And while the associated properties may be concurrently listed with the facilitator arrangement service and one or more other services, such as the Multiple Listing Service (MLS), in one exemplary embodiment of the present invention, the associated properties are listed with the facilitator arrangement service in lieu of a listing with other services.

In accordance with exemplary embodiments of the present invention, the facilitator arrangement 16 is capable of offering a real estate information exchange service to one or more buyer arrangements 12 and seller arrangements 14. Generally, the service provides a medium for buyers and sellers to communicate with one another without outside interference to facilitate the respective arrangements concluding a real estate sales or exchange transaction. And since buyers are typically reluctant to purchase property due to the risk of default of tenants leasing space within the property, if so desired, the service can also provide, for a period of time, insurance to the buyer against loss of income due to default of the existing tenants of the property, should a buyer and seller conclude the purchase/sale of a property. As described herein, such insurance may be referred to as “tenant default insurance.”

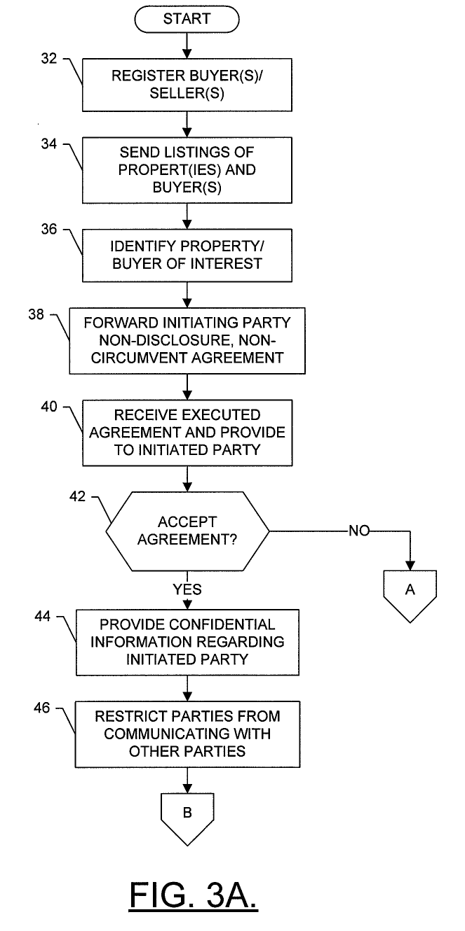

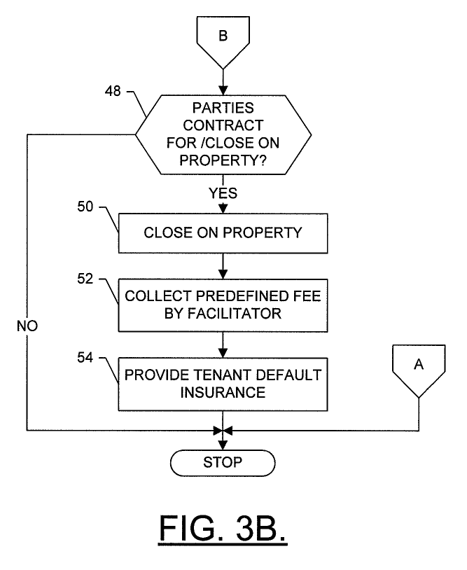

Reference is now made to FIGS. 3A and 3B, which illustrates various steps in a method of facilitating a real estate transaction, in accordance with one exemplary embodiment of the present invention. As shown in block 32, the method can include the one or more buyers and sellers of the buyer arrangements 12 and seller arrangements 14, respectively, registering with the facilitator arrangement 16, or more particularly with the service offered by the facilitator arrangement. Advantageously for the sellers, during the registration process of the buyers, information regarding the buyers can be generated, gathered or otherwise received by the facilitator arrangement. For example, the facilitator arrangement can gather information regarding the type of buyer (e.g., cash, joint venture, exchange, etc.), property purchases made by the buyer arrangements over a previous period of time (e.g., previous 12-24 months). The facilitator arrangement can then evaluate such buyer information to determine if the buyer information is accurate to thereby determine if the buyers are legitimate. For example, the facilitator arrangement can evaluate information regarding property purchases made by the buyer to determine the nature of the financing used to purchase the properties (e.g., all cash, mortgage, owner financing, equity trade, etc.). In addition, the facilitator arrangement can evaluate the buyer information to determine if the buyers are qualified to purchase an indicated level of real estate. In this regard, if the facilitator arrangement fails to determine that the buyers are legitimate and qualified, the facilitator arrangement can refuse to register the respective buyers. Otherwise, the facilitator arrangement can register the buyers with the service offered by the facilitator arrangement.

For the buyers, information regarding the properties of the sellers and/or the sellers themselves can be generated, gathered or otherwise received by the facilitator arrangement 16. The facilitator arrangement can then evaluate such seller information to allow the facilitator arrangement to provide data related to the properties. For example, the facilitator can receive and thereafter evaluate or otherwise confirm seller information including blueprints, aerial photos, zoning, certificates of occupancy, various regulatory approval letters, rent rolls, lease abstracts, parking ratios, setbacks, surveys, inspections, NOI's (net operating incomes), cap (capitalization) rates, appraisals, electronic property operating data (EPOD), EPOS-prop operating statements, deeds, mortgage information, financing packages, cash-on-cash projections, cash flow projections, comparables by radius, competition reports with tenant mix and local trend reports, as well as property specific mapping of income, population, consumer expenditure, retail sales and crime statistics.

In addition to the foregoing, the facilitator arrangement can receive, from one or more of the participants (e.g., one or more buyers and sellers of the buyer arrangements 12 and seller arrangements 14), information regarding the supply of properties owned by the participants, as well as the demand (and/or anticipated demand) for properties by the participants. In this regard, the participants may provide, to the facilitator arrangement, their asset base of properties including asset base criteria characterizing those properties such as, for example, property type, region, price range and/or quantity. Additionally or alternatively, participants may provide their acquisition criteria for a current time period (e.g., year) and/or one or more future time periods, where the acquisition criteria characterizes properties the respective participants anticipate purchasing (including those that the participants anticipate or otherwise desire to purchase) during the respective time period(s). Similarly, additionally or alternatively, participants and sellers may provide their disposition criteria for a current time period (e.g., year) and/or one or more future time periods, where the disposition criteria characterizes properties of the respective participants that the respective participants anticipate selling during the respective time period(s). In this regard, the disposition criteria for one or more properties of a participant may match the asset base criteria for those properties. Thus, from an asset base of properties each including asset base criteria, the asset base criteria for one or more properties the participant anticipates selling may be provided as disposition criteria for that participant.

The acquisition criteria and disposition criteria can be provided in any of a number of different manners, such as by performing searches of buyer arrangements and/or properties in the buyer database and/or property database (i.e., databases 38). The acquisition and disposition criteria can include any of a number of different criteria, and may be the same or different. In one exemplary embodiment, for example, the acquisition and disposition criteria are the same and may include one or more of property type, region, price and/or price range, cap rate and/or quantity. Additional information such as percentage occupancy, percentage of national tenancy, average lease terms remaining, location, MSA (metropolitan statistical area) or other market size, average remaining lease term, total square feet, acreage, number of parking spaces, year built, year of last renovation, traffic count, and/or demographic variables may be coded or entered as searchable field data enabling the searcher to broaden or narrow their search, alignment or correlation of the acquisition and disposition criteria.

After providing such information regarding an asset base, the facilitator arrangement 16 can provide, to the participants, a real-time forecast of industry projected purchases and/or sales based on total aggregation of the participants' acquisition criteria and/or disposition criteria, and/or the number of properties having matching respective criteria. This breakdown may be respectively referred to as “industry” supply and demand, and may forecast performance for a particular time period (e.g., year). Such information may be used, for example, as a rule of thumb for entities such as pension funds to make funds available for institutional buyers. Further, for-sale (or for-sale or held) properties including particular asset base criteria in the asset bases of the participants may show immediate, current real-time supply for properties with matching asset base criteria, and active searches by participants for properties including particular acquisition criteria may show immediate, current real-time demand for properties with matching acquisition criteria. This breakdown may be respectively referred to as “current” supply and demand. As explained herein, the terms “match,” “matching,” matches” or the like may be interpreted to encompass not only a complete match, but may additionally or alternatively include a substantial match. In this regard, a substantial match may include a match of a particular percentage (e.g., 70%), and/or a match of one or more particular pieces of information (e.g., property type, region, price range and/or cap rate) in a collection of information (e.g., asset base criteria).

More particularly, the facilitator arrangement 16 can provide, to a participant, real-time information regarding the number of properties in the asset bases of other participants having matching asset base criteria with the properties in the respective participant's asset base (industry assets). For example, a participant with an asset base including a property with certain asset base criteria may receive real-time information regarding the number of properties in the asset bases of other participants that match that certain asset base criteria. The facilitator arrangement can also provide, to a participant, real-time information regarding the number of properties having acquisition criteria (other participants anticipate purchasing) matching the asset base criteria of properties in the respective participant's asset base (industry demand), and/or real-time information regarding the number of properties having acquisition criteria matching the disposition criteria of the respective participants. For example, a participant with an asset base including a property with certain asset base criteria may receive real-time information regarding the number of properties (other participants anticipate purchasing) having acquisition criteria that match that certain asset base criteria. In addition, the facilitator arrangement can provide, to a participant, real-time information regarding the number of properties having disposition criteria (other participants anticipate selling) matching the asset base criteria of properties in the respective participant's asset base (industry supply).

The supply and/or demand may be broken down to provide information as to the number of matching properties in the collective asset bases, those having matching acquisition criteria, in a “hold” state, in a “for sale” state, and/or in an “engaged” state (the respective states being explained in greater detail below), and/or the number of historical sales of properties of the participants. The matching collective properties in the asset bases that are in the “for sale” state (or in either the “for sale” state or “engaged” state) may constitute current supply, and the properties that are in either the “hold” state or the “for sale” state that match active searches for similar properties may constitute current demand. As described herein, although information may be provided in real-time as that information is received, generated or the like, it should be understood that such information may alternatively be provided in a manner other than real-time, such as at one or more instances per a given time period (e.g., once per day).

The facilitator arrangement 16 may provide the aforementioned asset, supply and/or demand information to the participants in any of a number of different manners. For example, the facilitator arrangement may provide the number of instances of matching properties, matching acquisition criteria and/or matching disposition criteria adjacent to, or in a manner otherwise associated with, the respective properties of the participants. Thus, with this information, buyers and sellers are apprised, in real time, of the demand and/or supply for properties similar to the properties in their asset bases (as identified by the respective criteria).

As explained above, the facilitator arrangement 16 can provide, to a participant, information regarding the assets or asset bases of other participants. It should be understood, however, that the facilitator arrangement may additionally or alternatively provide, to a participant, information as to the number of matching properties in the collective asset bases of, those having matching acquisition criteria for, and/or those having matching disposition criteria for, all of the participants (including the respective participant and other participants).

Once in the asset base or any of the states within which a property may be placed (e.g., “hold” state, “for sale” state, etc.—explained below), the respective participant can adjust one or more criteria related to the property (e.g., reduce the cap rate), such as to measure demand for the property with different criteria. The participant can therefore determine a real-time value of the property based on the real-time demand for the property with specific criteria (e.g., at a specific price). More particularly, for example, consider a participant with an asset base including a property with certain asset base criteria, including a certain cap rate. In this regard, the cap rate may be searched or assessed by viewing additional criteria such as percentage occupancy, average remaining lease terms, market size, or certain demographic variables, for example. Also consider that the buyer database includes a particular number of buyer arrangements 12 with acquisition criteria matching the asset base criteria of the respective, thereby providing a measure of current demand for that property. In such instances, the participant may adjust one or more asset base criteria of the property, such as by adjusting the cap rate. In response, the service of the facilitator arrangement 16 may adjust the current demand to now reflect the number of buyer arrangements with acquisition criteria matching the adjusted asset base criteria. The participant may adjust the asset base criteria of the property at one or more instances. Accordingly, the participant may perform a real-time valuation of the property by identifying the number of interested buyers (those with matching acquisition criteria) for the property with different asset base criteria values.

As information regarding properties of the sellers is generated, gathered or otherwise received, the respective sellers or seller arrangements 14 may designate their properties as being in one of a number of different states, such as in a “hold” state or “for sale” state. In this regard, properties in the “for sale” state may be listed by the facilitator arrangement as being properties available for engagement in a real estate transaction, such as a real estate sale or exchange. Properties in the “hold” state, on the other hand, may be evaluated by the facilitator arrangement 16, but not otherwise listed as being available for engagement. At such time that the respective seller arrangement desires to list a held property for sale, the seller arrangement may merely move the property from the “hold” state to the “for sale” state, with the property already having been evaluated. Properties in the “hold” and/or “for sale” states may indicate, in real time, the number of buyers interested in similar properties (as identified by, e.g., matching asset base and acquisition criteria), and if so desired, also identify the types of interested buyers, such as cash, joint venture or exchange-type buyers (identified based on buyer information). Accordingly, the facilitator arrangement may triggered to notify buyer arrangements 12 of “for sale” properties as the respective seller arrangements change the state of those properties from “hold” to “for sale,” as explained below.

Before, after or as the facilitator arrangement 16 evaluates the buyer information or seller information, the facilitator arrangement can create an entry for the buyer or the seller in the buyer database or property database. Also, in accordance with the service provided by the facilitator arrangement, the facilitator arrangement can send the buyer arrangements 12 details of the for-sale properties of sellers stored in the property database (i.e., properties in a for-sale state), and send the seller arrangements 14 details of buyers stored in the buyer database (i.e., buyers available for purchasing one or more properties), as shown in block 34. In this regard, the details of properties and buyers can be sent to the buyer arrangements and seller arrangements, respectively, in any of a number of different manners. For example, upon registering with the service provided by the facilitator arrangement, the facilitator arrangement can send the buyer and seller arrangements currently active property and buyer details maintained in the property and buyer databases. Thereafter, as properties or buyers of interest to the buyer arrangements or seller arrangements are made available, such as by being entered into a respective database, the buyer arrangements or seller arrangements may receive a real-time availability alert notifying the respective arrangements of the newly available properties or buyers. The availability alert can be received in any of a number of different manners, such as by email, short message service (SMS), notification on a Web portal of the service or the like.

The real-time availability alert may also be filtered to limit its recipients. For example, the availability alert may be filtered by the sender so that only certain receivers may receive the alert. Also, for example, the availability alert may be filtered so that only principals can receive the alert followed by brokers a period of time later. Further, for example, the availability alert may be filtered so that only certain company types or companies of a certain size, or companies having a certain historical purchasing pattern, receive the alert.

As indicated above, properties may be maintained in the property database of the facilitator arrangement 16 in a hold state whereby the respective properties are not indicated as being available for engagement in a real estate transaction (it should be understood, however, that the foregoing may be equally applicable to buyers maintained in the buyer database). Properties in the hold state, however, have a number of characteristics viewable to the respective seller arrangement including, for example, the property type, cap, and region. In addition, properties in the hold state may also have associated therewith, and viewable to the respective seller arrangement, information such as the number of potential buyers (e.g., cash, exchange or joint-venture buyers) interested in purchasing properties having one or more characteristics of the respective properties. The seller arrangements 14 of the held properties or buyers may maintain the respective held properties until such time as the seller arrangements desire to make their properties available for engagement in a real estate transaction. The respective seller arrangement can then indicate their desire by moving the held property or buyer from a hold state to a for-sale state. In response to a property being moved from a hold state to a for-sale state (or otherwise being added to the respective database), the facilitator arrangement can then, in real-time or otherwise, send availability alerts to the buyer arrangements to thereby notify the buyer arrangements of the newly available property. As will be appreciated, the hold state not only permits the seller arrangement to take a property from being totally confidential to for-sale, but may also permit the seller arrangement to take a property from being totally confidential to an “engaged” state (and even have an upstream buyer in-hand for an exchange) without the respective property ever having been placed in the for-sale state. Moreover, and as indicated above, the hold state may further permit the participant to view real-time supply and/or demand information for those or similar properties.

Properties can be made available to the marketplace in varied states of exposure, such as totally or partially confidential, fully publicly-identified, or the like. For example, properties may be made partially confidential by allowing only certain possible responders (buyers) to see limited information about the property. In this regard, a seller arrangement 14 can direct the facilitator arrangement 16 to only send out an availability alert only to certain buyer arrangements 12. These buyer arrangements may include, for example, public REITs who have assets of at least one billion dollars, have purchased this type of asset in the past. Along with directing availability alerts only to certain buyer arrangements, the seller arrangement may additionally or alternatively direct the facilitator arrangement to permit buyer arrangements to see additional property criteria such as for example, MSA or city, or perhaps the exact address.

Irrespective of how or when the buyer arrangements 12 and seller arrangements 14 receive details of properties and buyers, the details can include any of a number of different pieces of seller information and buyer information, respectively. In one exemplary embodiment, for example, the details of properties and buyers include a portion of the seller and buyer information sufficient to allow the buyers and sellers to gauge an interest in one or more properties of the sellers or one or more buyers, respectively. To facilitate the buyers and sellers engaging the service of the facilitator arrangement 16, however, the details may not include information sufficient to permit the buyers or sellers to contact one another independent of the service.

After receiving the respective details at the buyer arrangements 12 and seller arrangements 14, the buyers can identify properties of interest, and the sellers can identify buyer arrangements of interest, as shown in block 36. If either a buyer or seller (i.e., the initiating party) desires to contact a seller or buyer (i.e., the initiated party), directly or as a result of actions of the facilitator arrangement, the facilitator arrangement can forward the initiating party arrangement a non-disclosure, non-circumvent facilitation fee agreement in which the initiating party agrees to pay the facilitator arrangement a predefined fee for the service provided by the facilitator arrangement should the initiating party and initiated party conclude a real estate transaction with one another, as shown in block 38.

After the initiating party (i.e., buyer or seller) executes the non-disclosure, non-circumvent facilitation agreement, and the initiating party arrangement (i.e., buyer arrangement 12 or seller arrangement 14) returns the executed agreement to the facilitator arrangement 16, the facilitator arrangement can forward the agreement to the initiated party arrangement (i.e., seller arrangement or buyer arrangement) for acceptance by the initiated party (i.e., buyer or seller), as shown in block 40. Provided the initiated party accepts the agreement (see block 42), the facilitator arrangement can provide, to the initiating party arrangement, confidential, access-restricted information related to the initiated party, as shown in block 44. The confidential information can be provided in any of a number of different manners, such as by forwarding the initiating party arrangement a password permitting the initiating party arrangement to access the confidential information. For example, the facilitator arrangement can permit a buyer arrangement to access confidential information comprising one or more pieces of seller information regarding the seller and/or the seller's property of interest to the buyer arrangement. The access-restricted seller information and buyer information can include any of a number of different pieces of information, including contact information for the seller and buyer, and one or more of the pieces of seller information and buyer information indicated above. However, at least a portion of the confidential information typically comprises information not having been included in the details previously sent to the buyer arrangement and seller arrangement (see block 34).

Irrespective of the confidential information provided to the initiating party arrangement, after the parties are engaged with respect to a particular property, the property can be moved into an “engaged” state, or be further associated with such a state (e.g., in addition to the for-sale state). Also, once the initiating and initiated parties are engaged in communication, the parties can be restricted from contacting other parties (i.e., other sellers and buyers) for a predefined engagement period (e.g., twenty-one days), which may or may not be extendible (e.g., mutually extendible). In this regard, the parties can be considered engaged in communication in any of a number of different manners. For example, the parties can be considered engaged in communication once the initiated party accepts the non-disclosure, non-circumvent agreement, or once the initiated party receives the password or uses the password to access information related to the initiated party, as shown in block 46. Irrespective of when the parties are considered engaged in communication, during the engagement period, the buyer can be restricted from communicating with other sellers regarding other properties. Likewise, the seller can be restricted from communicating with other buyers regarding the same property during the engagement period. The parties can be restricted from communicating with other parties in any of a number of different manners. For example, the facilitator can contractually restrict the parties from communicating with other parties. Additionally or alternatively, for example, the facilitator arrangement can remove, or otherwise restrict access to, the parties from the details of properties and buyers sent to other buyer arrangements 12 and seller arrangements 14 (see block 34). Advantageously, restricting each party from communicating with other parties during the engagement period can facilitate the parties concluding a real estate transaction with one another without outside interference.

If so desired, a seller arrangement 14 can further decide to allow multiple engagements (buyer arrangements 14), such as in the form of permitting multiple engagees to “bid” on the property at the end of an engagement period. In this scenario, the multiple engagees may have time and the exclusive right to pursue this property during the engagement period. This allows the buyer arrangements to align their acquisition criteria with a larger more eligible supply of properties.

After the initiating and initiated parties are engaged in communication, the parties may desire to conclude a real estate transaction regarding a property of the seller. In such an instance, the parties can conclude the real estate transaction in any of a number of different manners, such as by entering into a sales contract regarding a respective property and closing on the respective property, shown in block 48. In such instances, the facilitator can operate outside the transaction, or alternatively function as a broker for the transaction. In another alternative, the facilitator can engage a broker, closing agent or other facilitator for the transaction, with the facilitator and the engaged party entering into a separate agreement related to the brokering of the transaction. In either event, at the conclusion of the transaction, such as during closing of the property, the facilitator can collect the predefined fee from the initiating party for the service provided by the facilitator, as shown in blocks 50 and 52. Also at the conclusion of the transaction, if so desired and previously offered by the facilitator, the facilitator can provide the buyer with a limited duration tenant default insurance policy, as shown in block 54. For more information on such tenant default insurance, see U.S. patent application Ser. No. 10/890,457, entitled: System and Method for Insuring an Entity against Tenant Default with Respect to an Income-Producing Property, filed Jul. 13, 2004, the content of which is hereby incorporated by reference in its entirety.

In accordance with another, more particular exemplary embodiment of the present invention, a method is provided for facilitating a real estate exchange. Similar to before, the method can include registering buyer(s) and seller(s) of the buyer arrangements 12 and seller arrangements 14, respectively, with the facilitator arrangement 16, or more particularly with the service offered by the facilitator arrangement (see FIG. 3A, block 32). In accordance with this exemplary embodiment, an arrangement functioning as both a buyer arrangement and a seller arrangement to effectuate a real estate exchange may be referred to as an exchanger arrangement. Also similar to before, then, the method can include the facilitator arrangement generating, gathering or otherwise receiving, from the exchanger arrangement, information regarding the properties of the exchanger arrangement (seller arrangement for the sales portion of the exchange). As information regarding the exchangor's properties is received, the exchanger arrangement may designate the properties as being in one of a number of different states, such as in a “hold” state or “for sale” state, as indicated above.

Further, similar to before, the facilitator arrangement 16 can send the exchanger arrangement (buyer/seller arrangement 12, 14) details of the for-sale properties of sellers stored in the property database, and/or details of buyers stored in the buyer database. In this regard, as explained below, the method of facilitating a real estate exchange is described in a buyer-driven context whereby the exchangor arrangement receives details of for-sale properties and functions as the initiating party for the property purchase portion of the exchange, and as the initiated party for the property sale portion of the exchange. It should be understood, however, that the method may be equally applicable in a seller-driven context whereby the exchangor arrangement receives details of available buyers and functions as the initiating party for the property sale portion of the exchange, and as the initiated party for the property purchase portion of the exchange. Further, for example, the method may be equally applicable in a balanced context whereby the exchanger arrangement receives details of both properties and buyers or does not receive any details, and functions as either the initiating party or the initiated party for both the purchase and sale portions of the exchange.

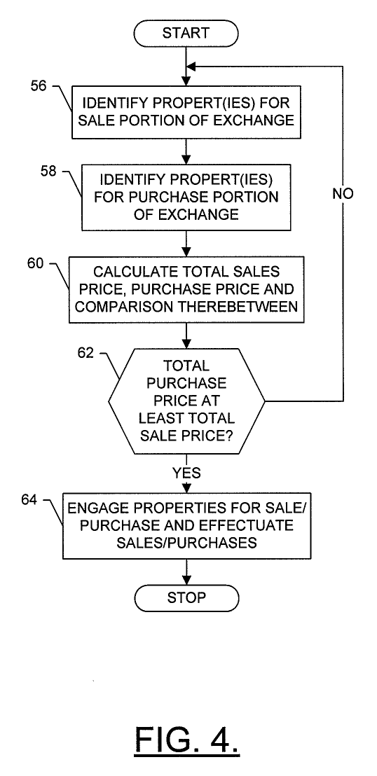

Referring now to FIG. 4, after registering the buyer(s) and seller(s) the exchanger arrangement (buyer/seller arrangement 12, 14) can identify one or more properties of the exchanger for the sale portion of the real estate exchange, as shown in block 56. The exchangor arrangement can identify the propert(ies) for the sale portion of the exchange in any of a number of different manners. In one exemplary embodiment, for example, the exchangor arrangement can identify the respective propert(ies) by moving one or more properties from the hold and/or for-sale states to an “exchange” state. In such instances, moving the respective propert(ies) into the exchange state may trigger the facilitator arrangement 16 to send, in real-time or otherwise, availability alerts to thereby notify the buyer arrangements of the newly available property in the case of moving the property from the hold state, or further facilitate selection of the available property in the case of moving the property from the for-sale state. Also in such instances, the exchanger arrangement can group the propert(ies) in the exchange state into one or more exchange transactions, or otherwise place the identified propert(ies) into existing exchange transactions. Accordingly, one group of one or more properties can be sold in a first exchange, while one or more other groups of one or more properties can be sold in second and subsequent exchanges.

Irrespective of when or how the propert(ies) for the sale portion of the exchange are identified, the exchanger arrangement (buyer/seller arrangement 12, 14) can also identify one or more properties for the purchase portion of the exchange, as shown in block 58. Similar to identifying the properties for the sale portion of the exchange, the properties for the purchase portion of the exchange can be identified in any of a number of different manners. For example, the respective properties can be identified from the details of the for-sale properties sent by the facilitator arrangement 16 to the exchanger arrangement. Additionally or alternatively, the respective properties can be identified from one or more searches of the property database for one or more for-sale properties meeting one or more search criteria (e.g., property type, geographic region, price range, expense offset, cap rate, availability, etc.). Similar to before, the for-sale properties can include a portion of the seller information sufficient to allow the exchanger to gauge an interest in the respective properties. Also similar to before, however, to facilitate the exchanger engaging the service of the facilitator arrangement 16, the seller information may not include information sufficient to permit the exchangor to contact the sellers of the respective properties independent of the service.

As shown in block 60, as the exchanger arrangement (buyer/seller arrangement 12, 14) identifies propert(ies) for the sale portion of the exchange, the facilitator arrangement 16 or exchanger arrangement can calculate, and present to the exchangor, a running total sale price of the respective properties. Similarly, as the exchanger arrangement identifies propert(ies) for the purchase portion of the exchange, the facilitator arrangement or exchanger arrangement can calculate, and present to the exchangor, a running total purchase price of the respective properties. The facilitator arrangement or exchanger arrangement can calculate, and present to the exchangor, a running comparison between the total purchase price and the total sale price. In this regard, it may be desirable or otherwise required for the real estate exchange that the total purchase price have a predetermined relation with respect to the total sale price, or vice versa. As shown in block 62, for example, it maybe desirable or otherwise required for the total purchase price to match or exceed (i.e., be at least) the total sale price, thereby resulting in a zero or otherwise positive difference between the total purchase price and the total sale price.

If the total purchase price is not at least the total sale price, the exchanger arrangement (buyer/seller arrangement 12, 14) may remove one or more properties identified for the sale portion of the exchange (see block 56), and/or identify one or more additional properties for the purchase portion of the exchange (see block 58). The running comparison can then be calculated to reflect the property removal and/or additional identification, such as to identify a total purchase price that matches or exceeds the total sale price. If not, the process of removing identified properties and/or identifying additional properties can continue until such a total purchase price is identified. As explained above, additional properties for the sale and purchase portions of the exchange can be identified, and/or identified properties can be removed from the exchange, before engaging any of the properties to effectuate the respective portions of the exchange. It should be understood, however, that identification and/or removal from the exchange of properties may occur at any point prior to completion of the real estate exchange. For example, the exchanger arrangement can identify one or more additional properties for purchase at any point before or after completing the sale of one or more of the identified properties for sale, and/or before or after completing the purchase of one or more other identified properties for purchase. Additionally or alternatively, for example, the exchanger arrangement can identify one or more additional properties for sale at any point before or after completing the purchase of one or more of the identified properties for purchase, and/or before or after completing the sale of one or more other identified properties for sale. Generally, then, the real estate exchange may be considered effectuated when the sales of identified properties for sale, and the purchases of identified properties for purchase, have been completed such that the total purchase price has the predetermined relation with respect to the total sale price, or vice versa.

After identifying properties for the sale portion and/or the purchase portion of the exchange, the exchangor arrangement (buyer/seller arrangement 12, 14) can engage those properties for a respective sale or purchase, and effectuate the sales and/or purchases of the respective properties, as shown in block 64. The properties can be engaged for sale and purchase, and the respective sales and purchases effectuated, in any of a number of different manners, such as in accordance with the method of facilitating a real estate transaction explained above with respect to FIGS. 3A and 3B. In a buyer-driven context such as that indicated above, then, the exchangor arrangement can function as the initiating party for the property purchase portion of the exchange, and as the initiated party for the property sale portion of the exchange. In such a context, for one or more identified properties of the property sale portion of the exchange, the exchangor (i.e., initiated party) can receive a non-disclosure, non-circumvent facilitation agreement from the facilitator arrangement 16, where the agreement has been executed by a buyer arrangement (i.e., initiating party) desiring to contact the exchanger with respect to one or more of those properties (see FIG. 3A, block 40). Provided the exchangor accepts the agreement (see block 42), the facilitator arrangement can provide, to the respective buyer arrangement, confidential, access-restricted information related to the exchangor (see block 44). Then, once the exchangor and the buyer are engaged in communication, the parties can be restricted from contacting other parties regarding the same respective property for a predefined engagement period (see block 46). Also once engaged in communication, the parties can conclude a real estate transaction regarding the respective property of the exchanger to thereby effectuate at least a portion of the sale portion of the exchange (see FIG. 3B, blocks 48-54).

For the property sales portion of the exchange, the facilitator arrangement 16 can forward the exchangor arrangement (i.e., initiating party) one or more non-disclosure, non-circumvent facilitation agreements (see FIG. 3A, block 38). In such instances, the facilitator arrangement can forward the exchanger arrangement a single agreement covering all of the identified properties for the purchase portion of the exchange. Alternatively, the facilitator arrangement can forward an agreement for each of the identified properties for the purchase portion of the exchange. Irrespective of the number of agreements forwarded to the exchangor arrangement, after the exchangor executes the non-disclosure, non-circumvent facilitation agreement(s), and the exchanger arrangement returns the executed agreement to the facilitator arrangement, the facilitator arrangement can forward the agreement to the seller arrangement 14 (i.e., initiated party arrangement) for acceptance by the respective seller (see block 40). Provided the seller accepts the agreement (see block 42), the facilitator arrangement can provide, to the exchanger arrangement, confidential, access-restricted information related to the identified property and the respective seller (see block 44). Similar to before, once the exchangor and the seller are engaged in communication, the parties can be restricted from contacting other parties regarding the same respective property for a predefined engagement period (see block 46). Also once engaged in communication, the parties can conclude a real estate transaction regarding the respective property of the seller to thereby effectuate at least a portion of the purchase portion of the exchange (see FIG. 3B, blocks 48-54).

For each identified property for sale and purchase, the exchanger can engage a buyer or seller arrangement 12, 14 to effectuate the respective sale or purchase, such as in the manner explained above. The real estate exchange, then, may be considered effectuated following the sales and purchases of identified properties such that the total purchase price has the predetermined relation with respect to the total sale price, or vice versa, as indicated above. As will be appreciated, once the sale of a property of the exchanger is complete, the respective property may be removed from the property database of the facilitator arrangement 16, or may otherwise have its ownership changed from the exchanger to the buyer. Similarly, once the purchase of a property by the exchangor is complete, the respective property may have its ownership changed from the seller to the exchanger. In either instance, once a property's ownership has been changed from one party to another, the property may be moved from a for-sale state to a hold state within the property database, the property thereby being made readily available for future transactions.

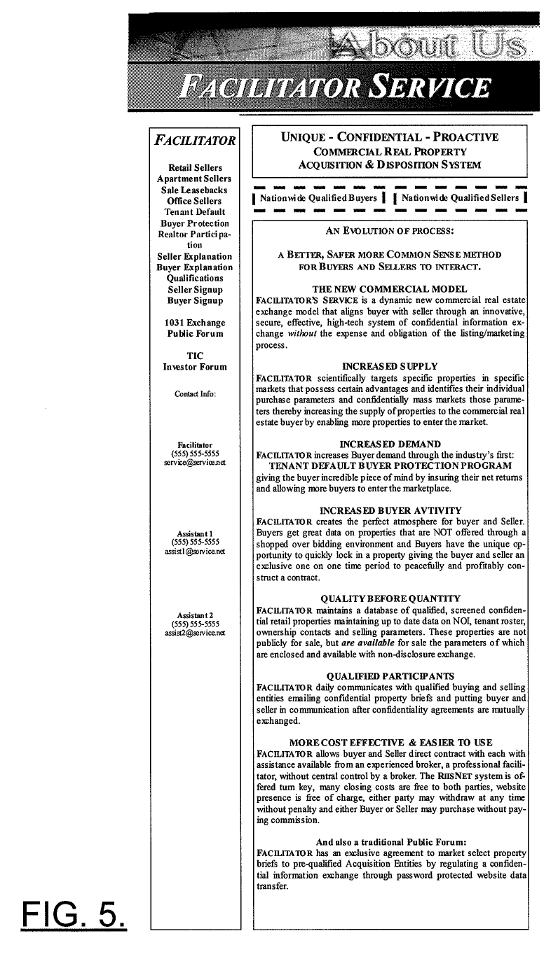

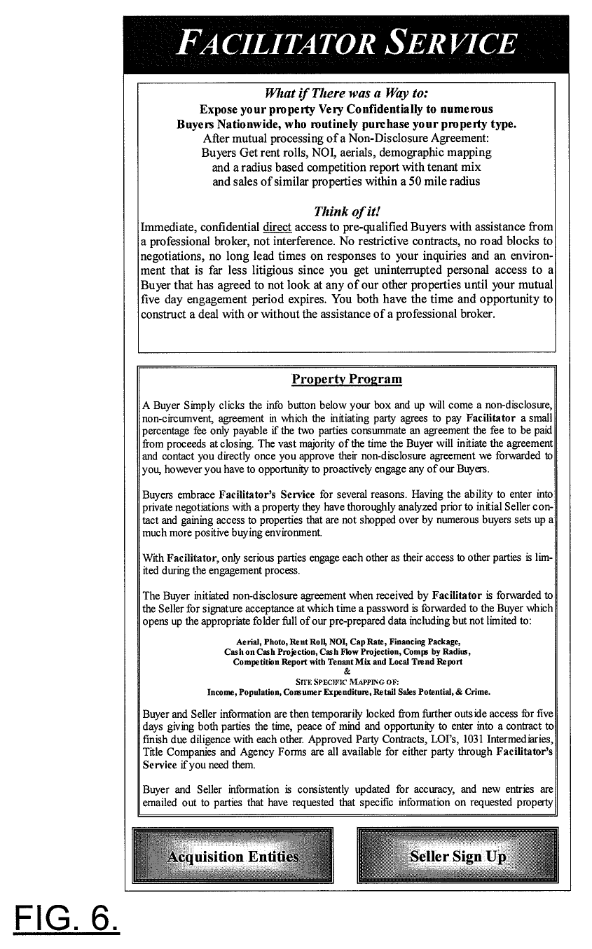

To further illustrate the benefits of the present invention, reference is now made to FIGS. 5-32, which illustrate exemplary displays, such as Web pages, capable of being provided by the facilitator arrangement 16 to the buyer arrangement 12 and/or seller arrangement. In this regard, although various ones of the displays and other figures include language further illustrating exemplary embodiments of the present invention, such language should not be taken to limit the spirit and scope of the present invention. The displays may be provided across the Internet (e.g., network 18), and thereafter presented by the respective arrangement for display to the buyer and/or seller. More particularly, as shown in FIG. 5, the facilitator arrangement can provide a portal that can explain the service offered by the facilitator arrangement, and include a number of links to other displays that permit the buyer arrangement and/or seller arrangement to engage the service. For example, the display of FIG. 5 can include a link to “Seller Explanation,” “Buyer Explanation” and “Program Qualifications” displays, which direct the facilitator arrangement to provide the displays of FIGS. 6, 7 and 8, respectively.

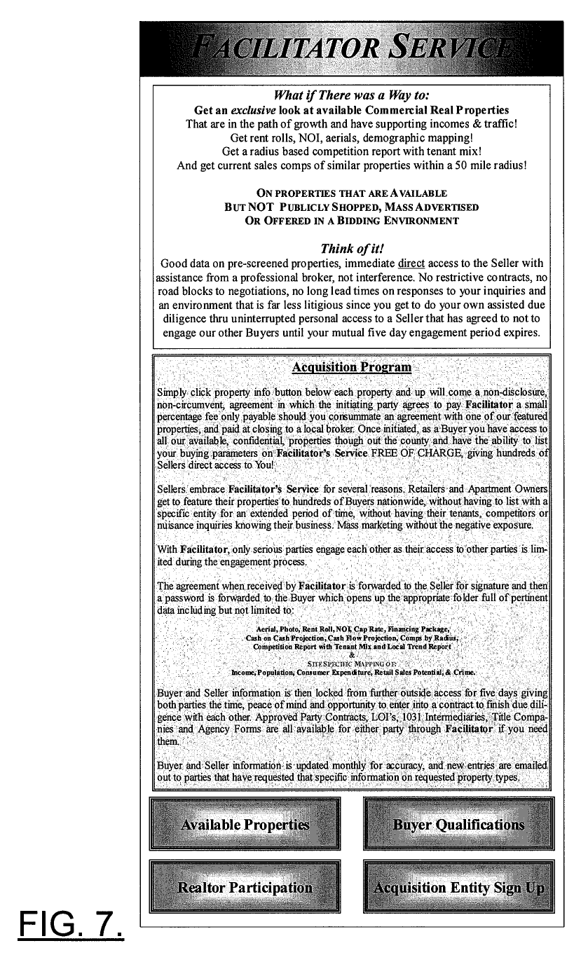

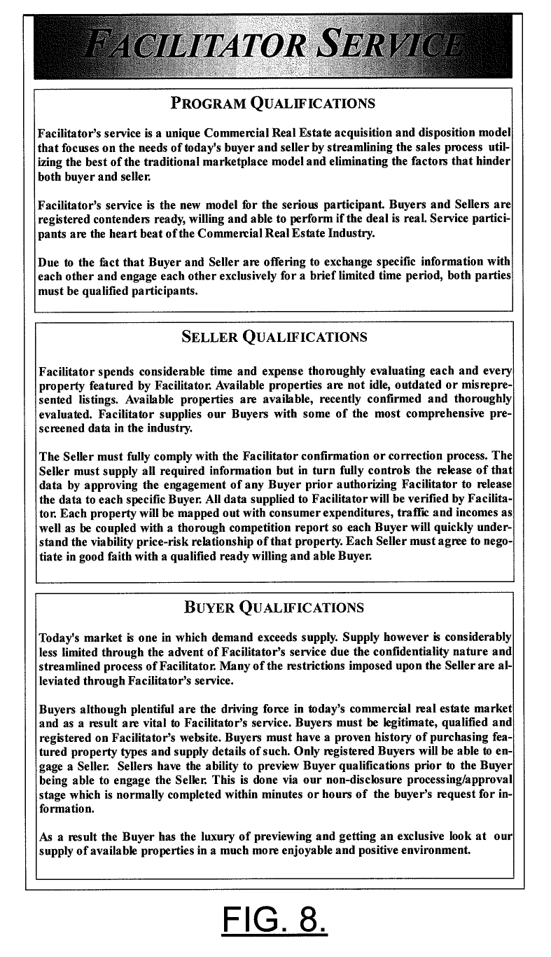

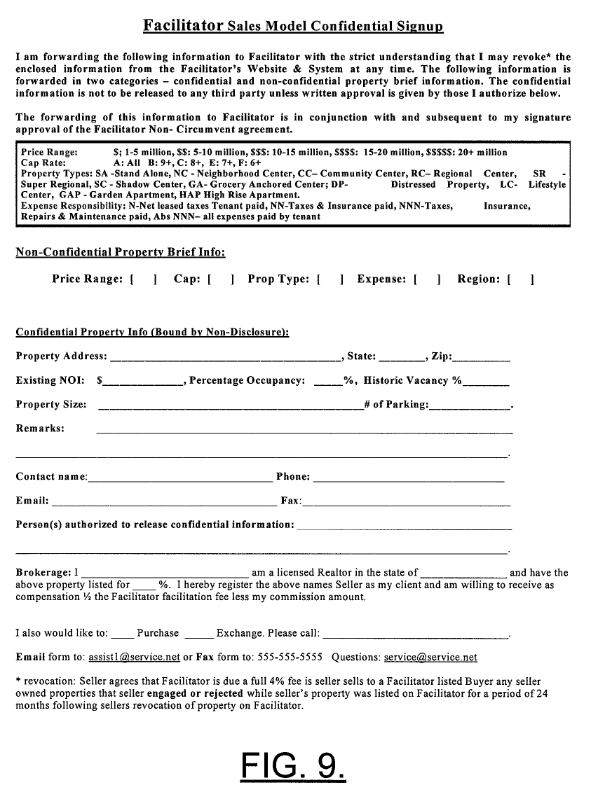

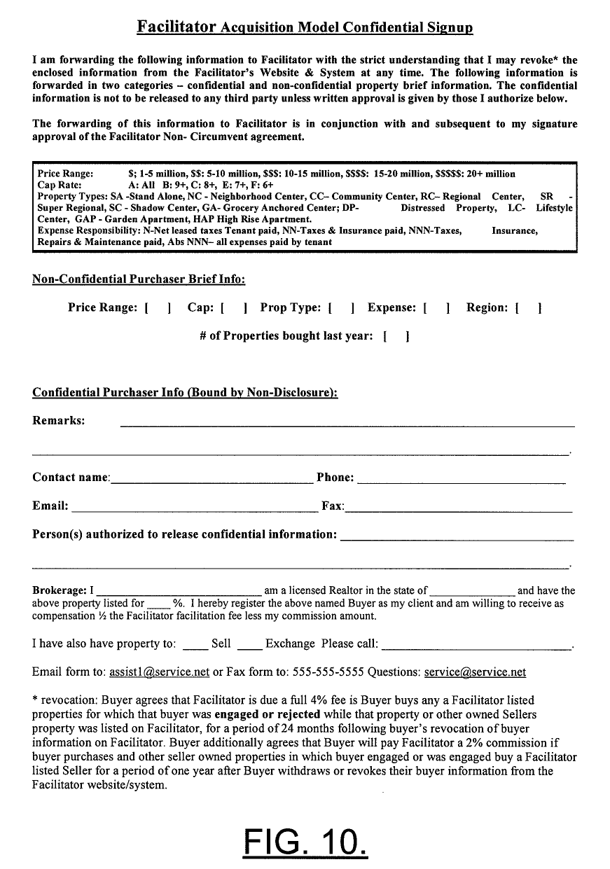

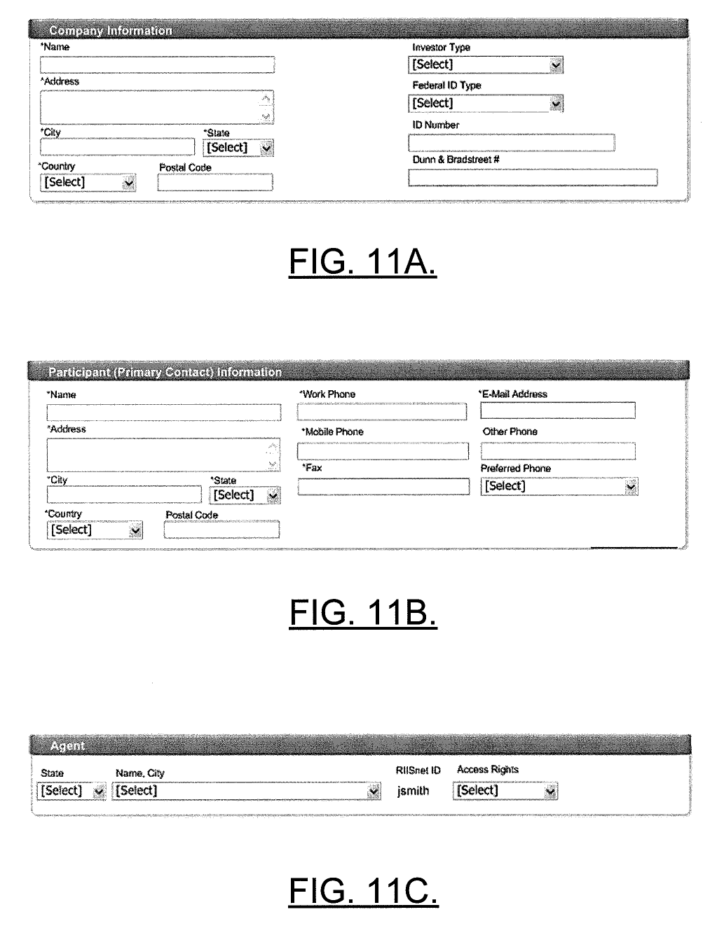

FIG. 6, then, illustrates a display that explains the service offered by the facilitator arrangement 16 to seller arrangements 14, and FIG. 7 illustrates a display that explains the service offered to buyer arrangements 12. FIG. 8, on the other hand, illustrates a display that explains the qualifications of the program or service, as well as that of seller arrangements and buyer arrangements participating in the program or service. In addition, the displays of FIGS. 6 and 7, as well as the portal display of FIG. 5, can include a link to permit a seller arrangement or a buyer arrangement to register with the facilitator arrangement, or more particularly with the service offered by the facilitator arrangement (see block 32 of FIG. 3A). Should a seller arrangement or buyer arrangement desire to register with the service, the seller arrangement or buyer arrangement can execute a respective link, which can direct the facilitator arrangement to provide the sign-up form displays of FIGS. 9 and 10, respectively. As shown in FIGS. 9 and 10, the seller arrangements and buyer arrangements can provide the facilitator arrangement with information regarding the properties of the sellers and/or the sellers themselves, or information regarding the buyers can be generated, gathered or otherwise received by the facilitator arrangement. For additional or alternative sign-up displays that may be provided to a seller arrangement or buyer arrangement during registration, and for the seller arrangement or buyer arrangement to provide the facilitator arrangement with appropriate information, see FIGS. 11A, 11B and 11C. As indicated above, after the facilitator arrangement 16 receives the buyer information or the seller information, the facilitator arrangement can evaluate the information to at least partially ensure that the buyers are legitimate and qualified to purchase an indicated level of real estate, or to allow the facilitator arrangement to provide data related to the properties of the sellers.

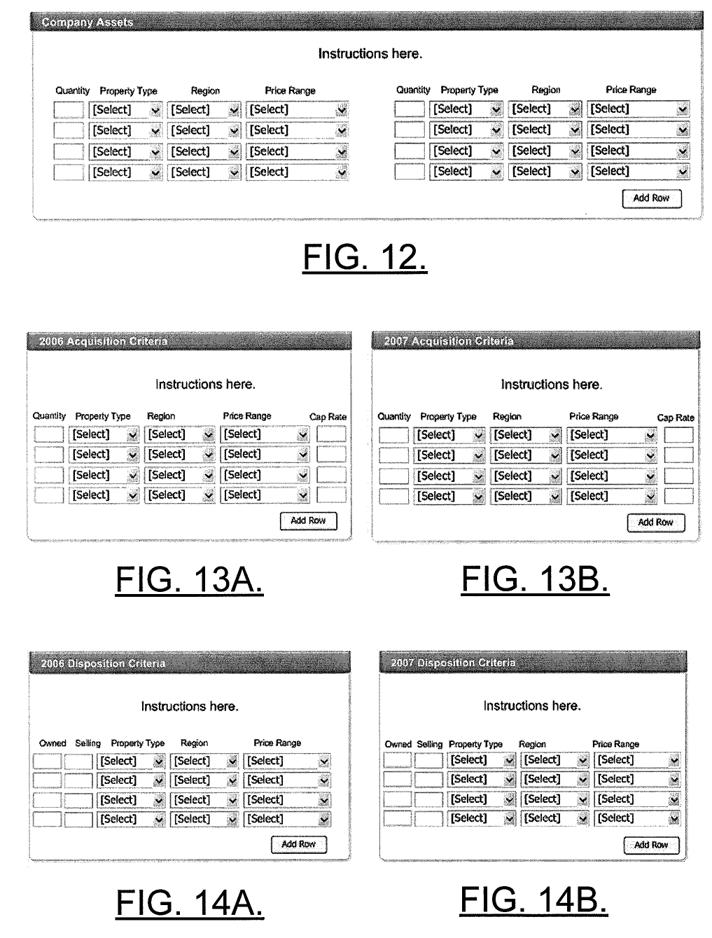

As indicated above and shown in FIG. 12, before, after or during registration, the participants may provide, to the facilitator arrangement 16, their asset base of properties including asset base criteria regarding those properties such as, for example, quantity, property type, region and/or price range. Additionally or alternatively, as shown in FIGS. 13A and 13B, participants may provide their acquisition criteria for a current time period (e.g., year) and/or one or more future time periods, where the acquisition criteria identifies criteria for properties the respective participants anticipate purchasing during the respective time period(s). Similarly, additionally or alternatively, as shown in FIGS. 14A and 14B, participants and sellers may provide their disposition criteria for a current time period (e.g., year) and/or one or more future time periods, where the disposition criteria identifies criteria for properties the respective participants anticipate selling during the respective time period(s).

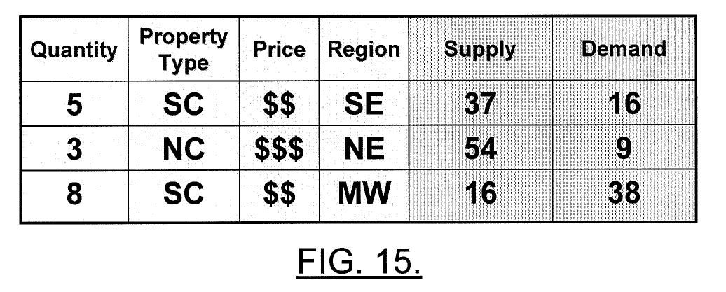

As shown in FIG. 15, for example, after providing information regarding an asset base, the facilitator arrangement 16 can provide, to a participant, real-time information regarding the number of properties having disposition criteria (other participants anticipate selling) matching the asset base criteria of properties in the respective participant's asset base (industry supply—shown in FIG. 15 as “supply”). In addition, and as also shown, the facilitator arrangement can provide, to a participant, real-time information regarding the number of properties having acquisition criteria (other participants anticipate purchasing) matching the asset base criteria (or even, within the asset base criteria, the disposition criteria) of properties in the respective participant's asset base (industry demand—shown in FIG. 15 as “demand”). Further, although not particularly shown in FIG. 15, the facilitator arrangement can provide, to the participant, current, real-time supply for properties with matching asset base criteria (for-sale—or for-sale or held—properties of other participants, and/or current-real time demand for actively-searched properties with matching asset base criteria.

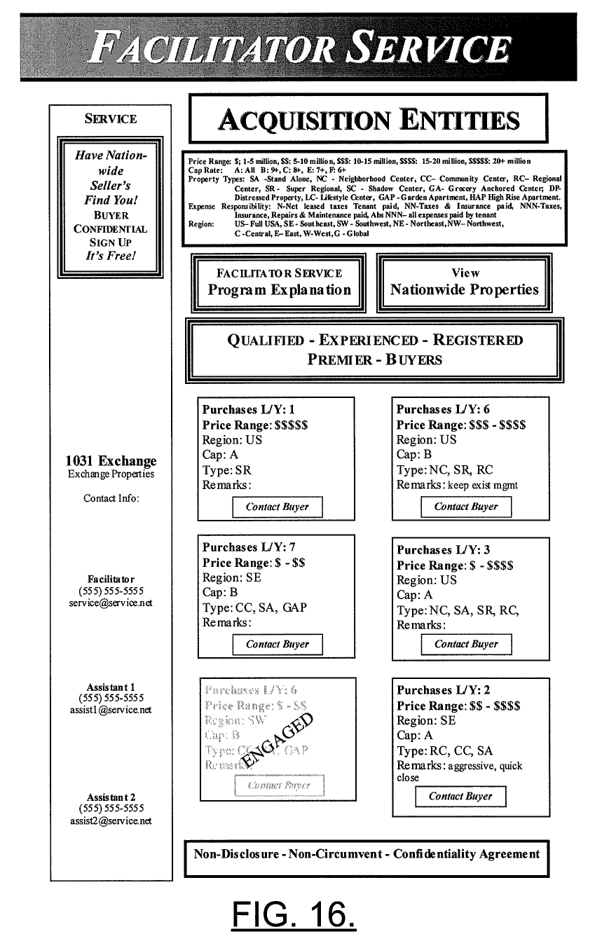

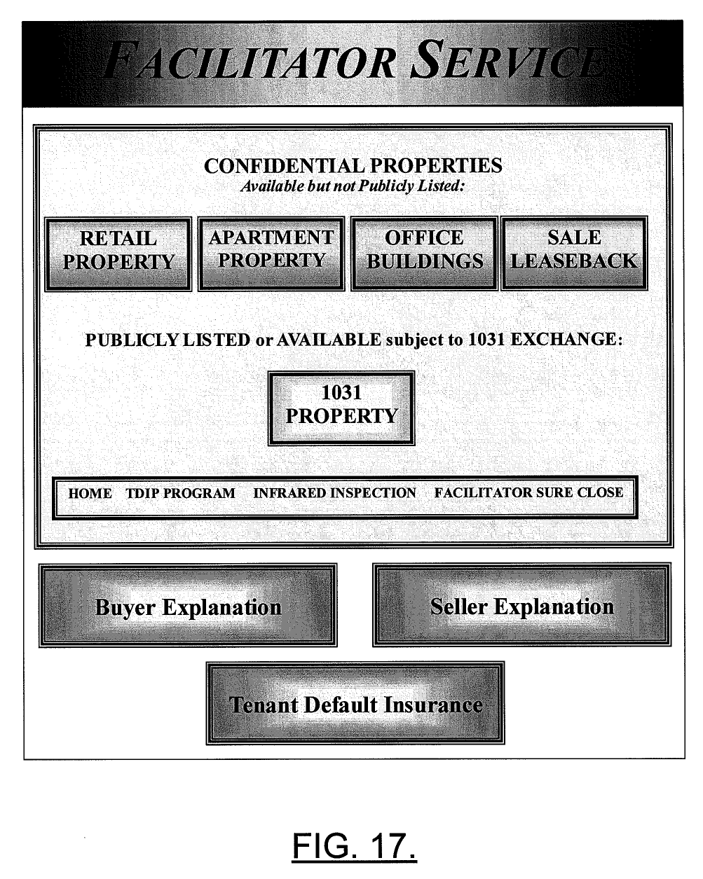

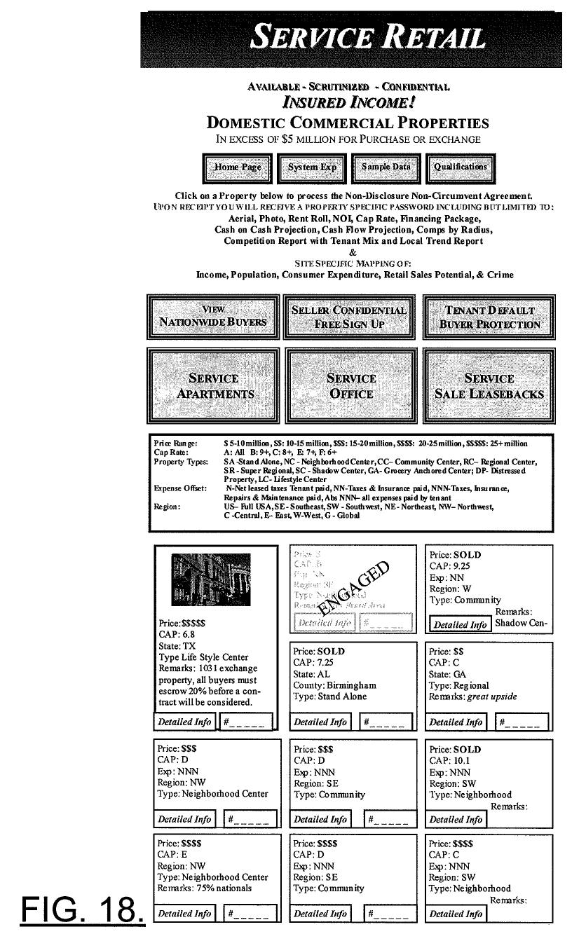

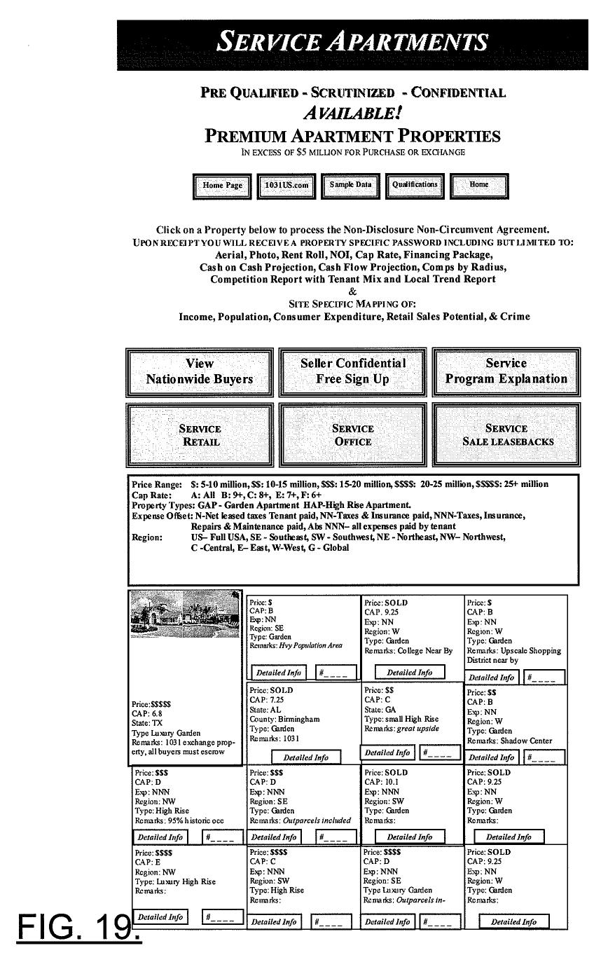

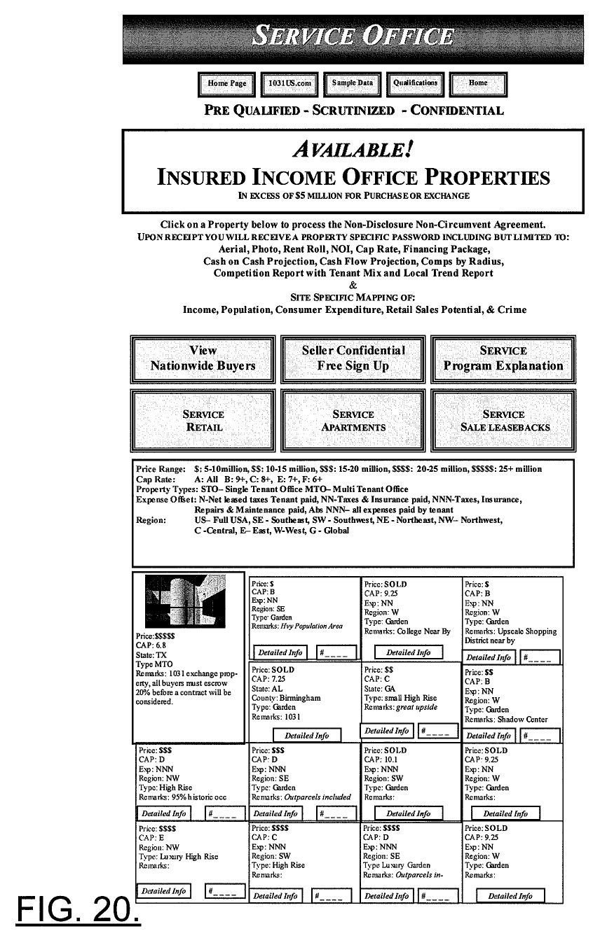

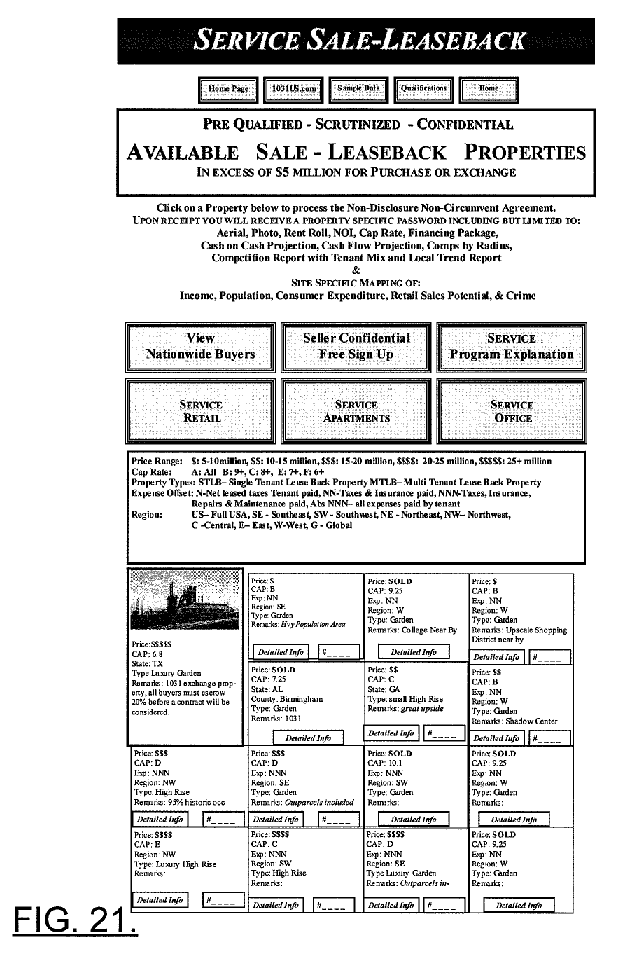

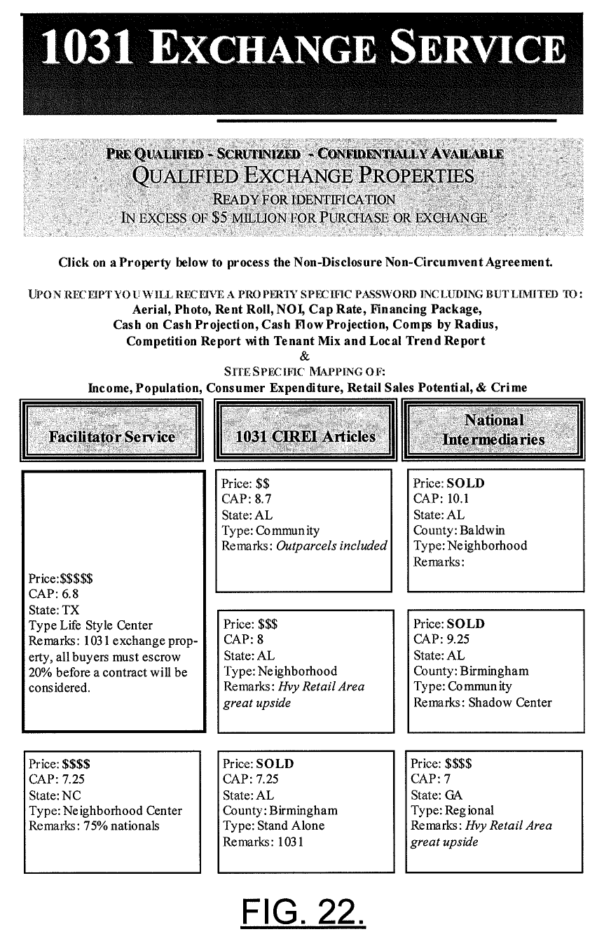

For buyer arrangements 12 and seller arrangements 14 registered with the service provided by the facilitator arrangement 16, as well as buyer and seller arrangements not registered with the service (if so desired), the facilitator arrangement provide details of buyers and properties (see block 34 of FIG. 3A). More particularly, as shown in FIG. 16, the facilitator arrangement can provide a display of acquisition entities (i.e., buyers), including a portion of the buyer information stored in the buyer database, the buyer information being sufficient to allow sellers to gauge an interest in the buyers. As shown in FIG. 17, the facilitator arrangement can provide a portal to details of confidential retail, apartment, office and sale-lease back properties, as well as publicly listed or available properties subject to IRS 1031 tax deferred exchange. From the portal of details (as well as the portal of FIG. 5), the facilitator arrangement can provide displays of retail properties (FIG. 18), apartment properties (FIG. 19), office properties (FIG. 20), sale-lease back properties (FIG. 21), 1031 properties (FIG. 22) and/or land, condominium complexes, industrial and/or non-real estate properties (not shown). Within each display, then, the facilitator arrangement can include details of respective properties, as well as a portion of the seller information stored in the property database, the portion of the information being sufficient to allow buyers to gauge an interest in the properties.

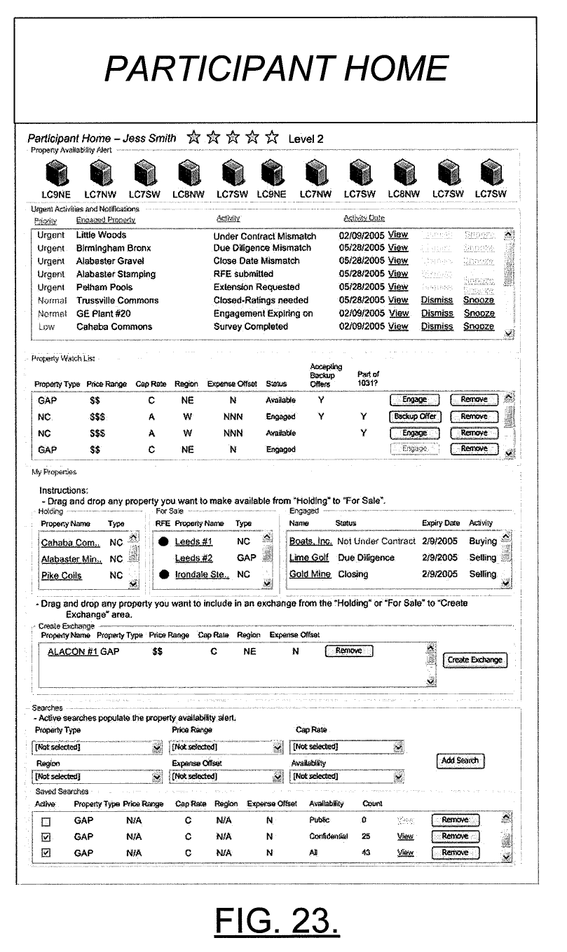

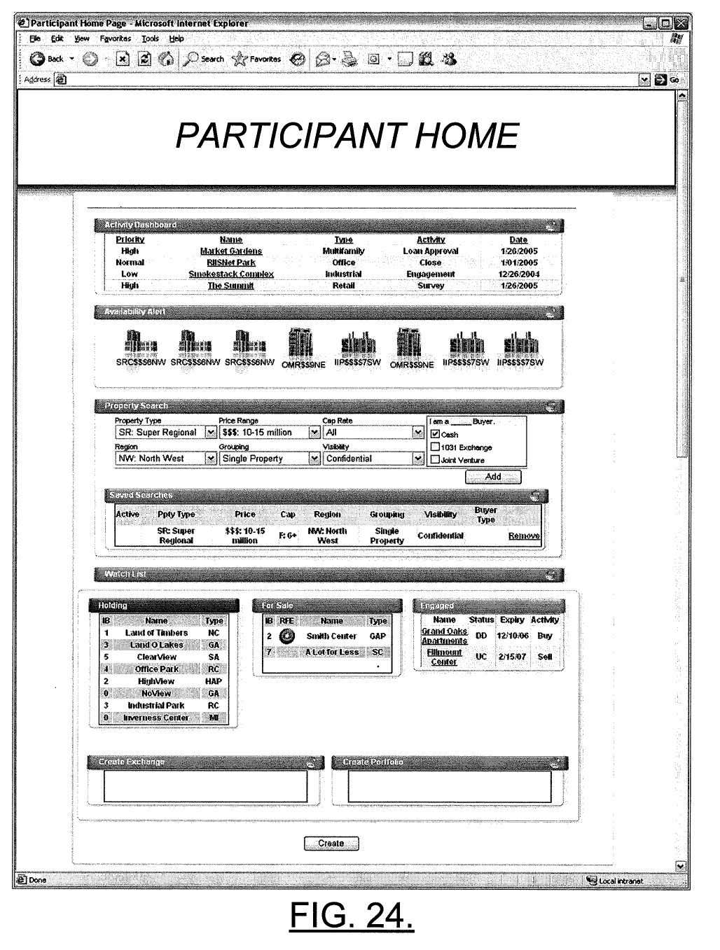

For registered buyer arrangements 12 and seller arrangements 14 registered with the service provided by the facilitator arrangement 16, the facilitator arrangement can provide a participant home page or display from which the respective party can manage their real-estate portfolio and activity with respect to the service, as shown in various exemplary embodiments in FIGS. 23 and 24. In this regard, the participant home page can include an availability alert portion (shown under the heading “property availability alert” in FIG. 23, and the heading “availability alert” in FIG. 24) including details of newly available properties (or buyers), and an activity dashboard portion (shown under the heading “urgent activities and notifications” in FIG. 23, and the heading “activity dashboard” in FIG. 24) including details of properties undergoing recent changes (e.g., lease review, completed appraisal, request for engagement—RFE, etc.) to their respective records in the property database. Additionally or alternatively, for example, the participant home page can include a property watch list including details of for-sale properties that meet the participant's predefined search criteria.

Also, for example, the participant home page can include a hold, sell, engaged property portion (shown under the heading “my properties” in FIG. 23) including separate details of properties of the participant in the hold state, for-sale and engaged states. As also shown, the engaged properties details can further include a status of the properties respective engagements, an expiration of the respective engagements, and/or whether the participant is the potential buyer or seller with respect to the respective engagements. In addition, for example, the participant home page can include a search matrix portion (shown under the heading “searches” in FIG. 23, and the heading “property search” in FIG. 24) from which the participant can search for-sale properties in the property database of the facilitator arrangement 16 based upon one or more search criteria (e.g., property type, square footage, geographic region, State, MSA, market size, price range, expense offset, cap rate, availability, average lease term remaining, percentage occupancy, percentage of national or credit tenants, etc.). Additionally, the search matrix portion may permit advanced searches whereby one or more criteria (e.g., price range, etc.) may be broadened, and/or one or more criteria (e.g., State, square footage, etc.) may be narrowed. The search criteria thereafter being used, for example, to specify the properties for which the participant receives availability alerts.

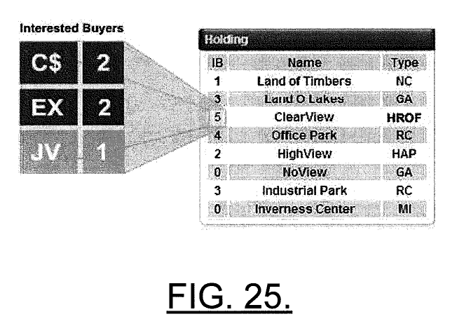

As shown in the exemplary embodiment of FIG. 24, the participant home page may additionally include, for properties in the hold (“holding”) and/or for-sale states, real-time (or otherwise) information indicating the number of buyers interested (interested buyers, or “IB”) in similar properties (e.g., current demand identified by matching active searches). And as further shown in FIG. 25, if so desired, the participant home page may also identify the types of interested buyers, such as cash (shown as “C$”), joint venture (shown as “JV”) or exchange-type buyers (shown as “EX”), which may be identified based on buyer information.

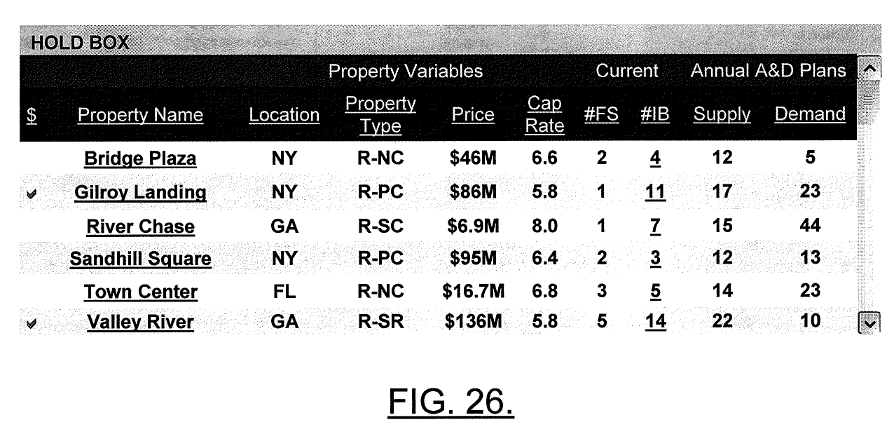

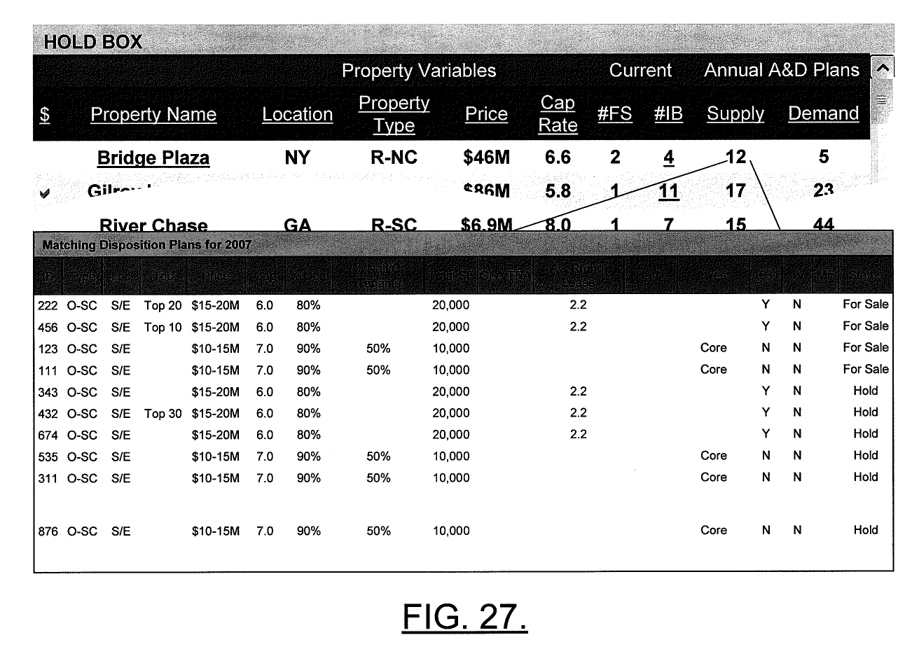

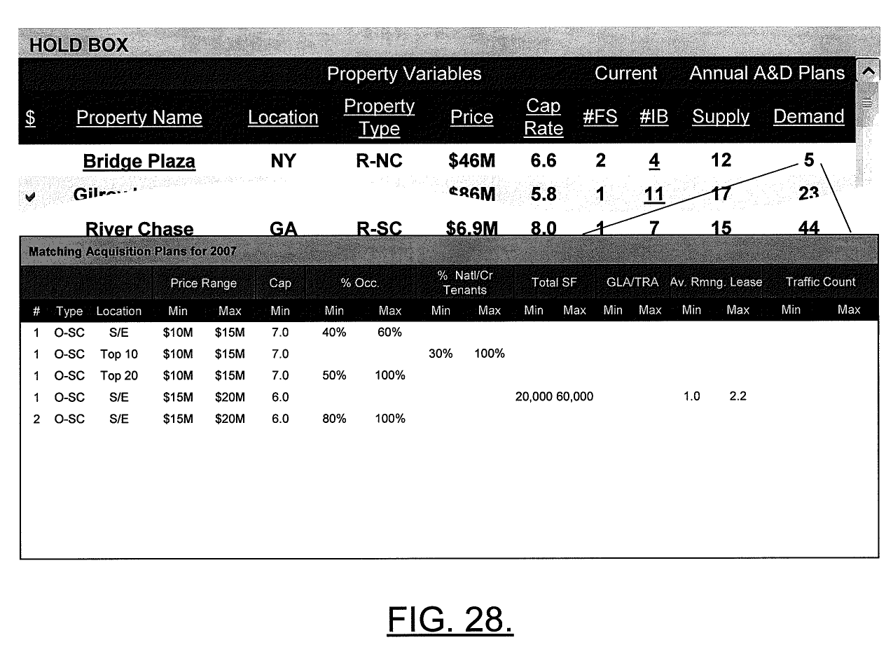

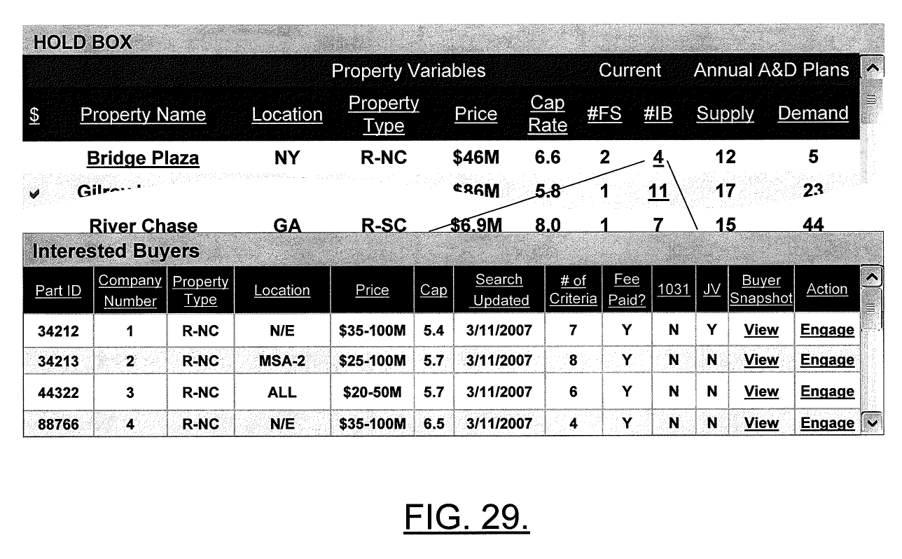

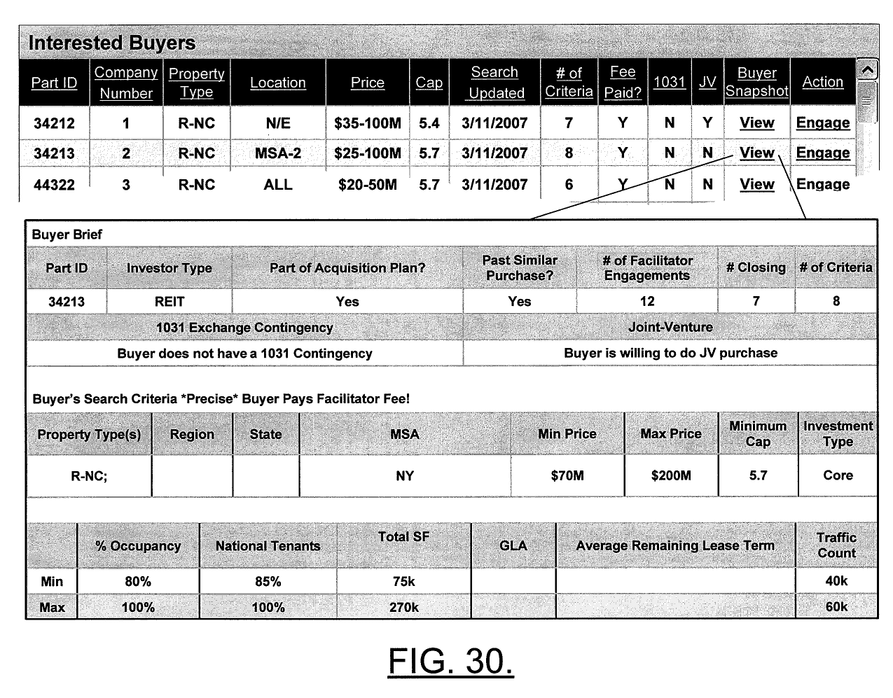

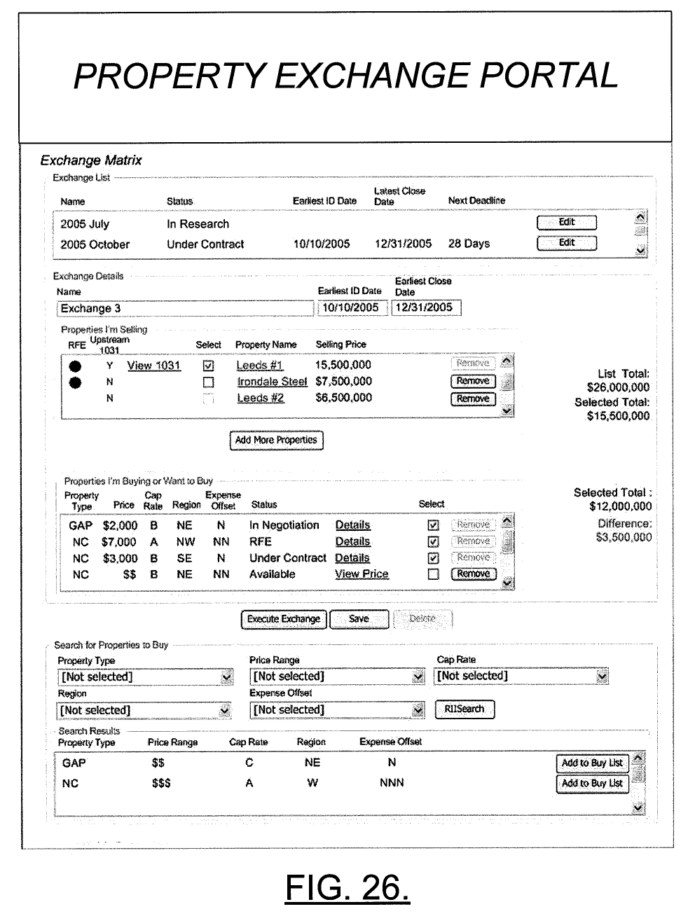

Further exemplary displays of the hold-state portion of a participant home page, including even more details of properties in the hold state is shown in FIGS. 26-30. As shown in FIGS. 26-29, the hold-state portion of a participant home page may include any of a number of different pieces of information related to properties of the participant including, for example, the name, location, property type, price, cap rate, current supply (#FS—number for sale), current demand (#IB), industry supply and/or industry demand. And as also shown in FIGS. 27-30, even further information may be provided to the participant as to at least a portion of the information related to respective properties, such as in response to a request for such information from the participant. For example, participant viewing the home page may select, for a particular property, one or more of industry supply, industry demand, current supply and/or industry demand to receive even further information regarding the properties being included making up such supply and/or demand values. This further information may be provided in a number of different manners, such as in a further portion of the participant home page, in a separate window or page overlaying a portion of the participant home page, or the like. As shown in FIGS. 27 and 28, for example, the participant may select industry supply or demand to receive further information regarding the properties making up the industry supply or demand, respectively. As shown in FIG. 29, for example, the participant may select current demand (#IB) to receive further information regarding the properties (or active searches) making up the current demand. In addition to information regarding the properties (or active searches) making up the current demand, the participant may receive even further information regarding the other participants actively searching for those respective properties (buyer snapshot or brief), as shown for example in FIG. 30.

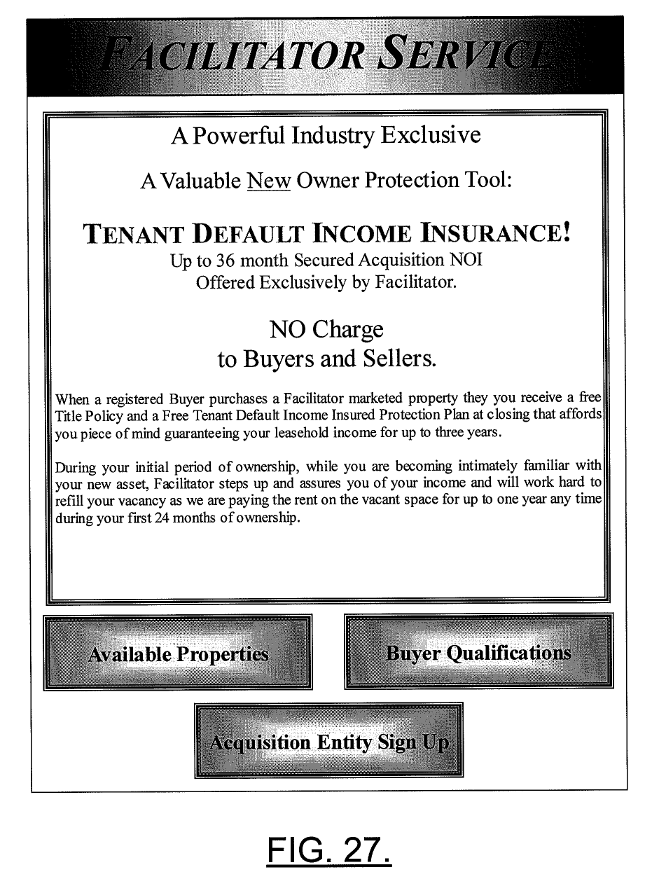

Referring back to the exemplary participant home page of FIGS. 23 and 24, the participant home page can include an exchange matrix populator portion (shown under the heading “create exchange”) from which the participant can initiate a real estate exchange with respect to one or more properties of the participant. In this regard, the participant home page can be configured such that the participant can initiate a real estate exchange by dragging one or more properties from the details of held and/or sale properties (e.g., in the hold, sell, engaged property portion), and dropping those propert(ies) in the exchange matrix populator portion, the respective propert(ies) being identified for the purchase portion of an exchange by the dragging and dropping operations (see FIG. 4, block 56). To continue a real estate exchange, the participant (i.e., exchanger) can then be directed to an exchange portal, such as that shown in FIG. 31.

Although not shown, the participant home page can include further tools for managing their activity with respect to the service. For example, the participant home page can include a portfolio portion including one or more real estate portfolios defined by the participant, each portfolio including a group of properties that, for various events, may be treated as a collective whole. Also, for example, the participant home page can include a tenant-in-common (TIC) portion including one or more properties, and/or one or more groups of properties, for which the participant has a TIC ownership with one or more other TIC owners, who may or may not be participants of the service. Further, for example, the participant home page can include a portion including one or more upstream Gantt charts for properties under contract, each Gantt chart identifying one or more tasks to be completed to conclude a transaction such that the participant can view their progression to conclusion of the transaction.

As shown in FIG. 31, the exchange portal can include an exchange list portion for managing different real estate exchange transactions, and the properties included in each transaction. The exchange portal can also include details of properties identified for the sale portions of the different exchange transactions (shown under the heading “properties I'm selling”), where the properties identified or identifiable for particular exchange transactions (e.g., “exchange 3”) can be shown via a check box (checked or un-checked). The exchange portal can further include a property search portion (shown under the heading “search for properties to buy”) from which the exchangor can search for-sale properties in the property database of the facilitator arrangement 16 based upon one or more search criteria. From the results of such searches, then, the exchanger can identify one or more properties for the purchase portion of the exchange (see block 58), those properties being included in details of such properties (shown under the heading “properties I'm buying or want to buy”).

As further shown in FIG. 31, as the exchanger arrangement (buyer/seller arrangement 12, 14) identifies propert(ies) for the sale portion of the exchange, a running total sale price of the respective properties can be calculated and presented on the exchange portal (see block 60). Similarly, as the exchangor arrangement identifies propert(ies) for the purchase portion of the exchange, a running total purchase price of the respective properties can be calculated and presented on the exchange portal. Further, a running comparison (e.g., difference) between the total purchase price and the total sale price can be calculated and presented on the exchange portal. Thus, the exchanger may continue by identifying additional properties, and/or removing identified properties from the exchange, until a predetermined relationship between the total purchase price and total sale price is met (e.g., total purchase price at least the total sale price) (see block 62).

The exchange portal can further include a button or other selectable element (shown as “execute exchange”) such that, after identifying properties for the sale portion and/or the purchase portion of the exchange, the exchangor execute the exchange to thereby initiate engaging the identified properties (see block 64). Then, as explained above, for those properties for which the exchangor is the initiating party (e.g., for the purchase portion of the exchange), the exchanger can receive from the facilitator arrangement 16, and thereafter execute, a non-disclosure, non-circumvent facilitation agreement. Then, after the exchanger has accepted the agreement, the facilitator arrangement can provide, to the exchangor arrangement, confidential, access-restricted information related to the initiated party (see blocks 38-44 of FIG. 3A). In contrast, for those properties for which the exchanger is the initiated party (e.g., for the sale portion of the exchange), the exchanger can receive, for acceptance, a non-disclosure, non-circumvent facilitation agreement executed by the initiating party.

Once the exchanger and initiating/initiated parties are engaged in communication for properties of the exchange, the parties can be restricted from contacting other parties with respect to those properties for a predefined engagement period (e.g., five days). For example, the facilitator arrangement 16 can restrict access to the buyer arrangement 14 and the respective property of the seller arrangement 14 from the details of buyers and properties. In this regard, the facilitator arrangement can restrict access to the buyer arrangement by blanking out the entry for the buyer in the display of buyers and identifying the buyer as being “Engaged,” shown in FIG. 16. Similarly, the facilitator arrangement can restrict access to the respective property by blanking out the entry for the property in the display of properties and identifying the property as being “Engaged,” shown in FIG. 17. As indicated above, by restricting each party from communicating with other parties during the engagement period, the facilitator arrangement can facilitate the parties concluding a real estate transaction with one another without outside interference.

After the exchanger and initiating/initiated parties are engaged in communication, if the parties can conclude real estate transactions for the respective properties to thereby effectuate the real estate exchange (see block 48), the facilitator can collect predefined fees from the initiating party for the service provided by the facilitator (see blocks 50 and 52). Also at the conclusion of the transactions, if so desired and previously offered by the facilitator, the facilitator can provide the buyer with a limited duration tenant default insurance policy (see block 54). In this regard, as the buyer arrangements 12 and seller arrangements 14 engage the service offered by the facilitator arrangement 16, the facilitator arrangement can provide the buyer arrangements and seller arrangements with information regarding such a policy, as shown in the display of FIG. 32. And by providing such information, the facilitator arrangement can facilitate the buyer arrangements and seller arrangements registering with the service offered by the facilitator arrangement, and concluding a transaction while engaging the service.

As will be appreciated, the service of the facilitator arrangement 16 described herein can be provided in a number of different contexts relating to real estate, from commercial to residential real estate. It should be understood, however, that the service can generally be provided in any of a number of different contexts involving a buyer and a seller of a good. For example, the service can be provided by the facilitator arrangement in the context of an auction offering of a good by a seller to a number of buyers, such as in the context of an online auction (e.g., eBay).

Also, the tenant default insurance described herein can be provided in conjunction with a real estate transaction between a buyer arrangement 12 and a seller arrangement 14. It should be understood, however, that the tenant default insurance can be provided independent of such a transaction, without departing from the spirit and scope of the present invention. For example, the tenant default insurance can be provided to a buyer arrangement independent of the transaction between the buyer and a seller of a respective property. Alternatively, for example, the tenant default insurance can be provided to an owner of a property at any point during the ownership tenure of the owner. Also, it should be understood that the tenant default insurance can also be provided in conjunction with other investment tools such as tenant-in-common ownership, REIT (real estate investment trust) ownership and/or IRS 1031 tax deferred exchange programs to create a new investment vehicle that offers a guarantee of a certain level of income to the new buyer during initial ownership, or during a period extending beyond initial ownership, if so provided by the facilitator arrangement.

Further, the aforementioned acquisition and/or disposition criteria may also have applicability in effectuating a percentage ownership transaction (e.g., tenant-in-common (TIC) transaction) for one or more properties. In this regard, the facilitator arrangement 16 may be configured to aggregate acquisition criteria of various participants (e.g., accredited and/or non-accredited investors). The facilitator arrangement may then review the aggregated acquisition criteria and organize or sort groups of participants by similar acquisition criteria, and may further include numbers of participants in particular groups as may be desired or otherwise required to effectuate a percentage ownership transaction (generally or for one or more particular properties). Similarly, the facilitator arrangement may be configured to aggregate disposition criteria for various properties, and organize or sort groups of properties by similar disposition criteria. The facilitator arrangement may then align one or more groups of participants with one or more groups of one or more properties (e.g., currently for-sale properties and/or properties identified for future sale by their disposition criteria) to facilitate percentage ownership offerings and ultimate conclusion of percentage ownership transactions. Further, if so desired, tenant-default insurance may be offered in conjunction with a percentage-ownership offering to thereby create an offering whereby the respective propert(ies) may be insured against default of existing tenants at the conclusion of the transaction, where in one exemplary embodiment, those tenants have been judged to be creditworthy at that time.

After acquiring a percentage ownership in one or more properties, an owner-participant may sell, exchange or otherwise transfer all or a portion of the respective percentage to other entities (e.g., buyer arrangements 12). Thus, it should be understood that percentage ownerships (and, if desired, any accompanying tenant default insurance) may be bought, sold, exchanged or otherwise transferred from one entity to another. In this manner, percentage ownerships in properties may function in a manner similar to shares of a publicly-traded stock. Further, as indicated above, the addition of tenant-default insurance may make investment in the propert(ies) more conservative and thus in greater demand by those seeking safer investments yielding lower, more conservative buyer returns.

According to one aspect of the present invention, all or a portion of the system of the present invention, such as all or portions of the buyer arrangement 12, seller arrangement 14 and/or facilitator arrangement 16, generally operates under control of a computer program product. The computer program product for performing the methods of exemplary embodiments of the present invention includes a computer-readable storage medium, such as the non-volatile storage medium, and computer-readable program code portions, such as a series of computer instructions, embodied in the computer-readable storage medium.

In this regard, FIGS. 3A, 3B and 4 are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowcharts.

Accordingly, blocks or steps of the control flow diagrams support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A facilitator arrangement comprising:
a computer-readable storage medium; and
a processor configured to receive, and store in the computer-readable storage medium, asset base criteria for one or more properties of a participant, the asset base criteria characterizing the respective one or more properties of the participant,
wherein the processor is configured to receive, and store in the computer-readable storage medium, acquisition criteria for one or more properties one or more other participants anticipate purchasing, the acquisition criteria characterizing the respective one or more properties the one or more other participants anticipating purchasing,
wherein the processor is configured to provide, to the participant, a number of properties the one or more other participants anticipate purchasing that have acquisition criteria matching the asset base criteria of the respective one or more properties of the participant,
wherein the processor is configured to provide the number of properties for display by the participant, the number of properties being displayed as a measure of demand for the one or more properties of the participant.

2. A facilitator arrangement according to claim 1, wherein the processor is further configured to receive asset base criteria for one or more properties of one or more other participants,
wherein the processor is configured to provide, to the participant, a second number of properties of one or more other participants that have asset base criteria matching the asset base criteria of the respective one or more properties of the participant, and
wherein the processor is configured to provide the second number of properties for display by the participant, the second number of properties being displayed as a measure of supply of one or more properties.

3. A facilitator arrangement according to claim 1, wherein the processor is further configured to receive an adjustment of the asset base criteria for a property of the participant, and
wherein the processor being configured to provide the number of properties includes the processor being configured to update the number of properties provided to the participant.

4. A facilitator arrangement according to claim 3, wherein the asset base criteria include a plurality of criteria selected from the group consisting of property type, region, price range and capitalization rate.

5. A facilitator arrangement comprising:
a computer-readable storage medium configured to store a database including information associated with a real-estate portfolio of a participant, the real-estate portfolio including a plurality of properties of the participate, the properties initially being in a hold state in the database; and
a processor configured to receive selection of a property in the portfolio for offering the respective property for sale,
wherein the processor is configured to move the selected property from the hold state to a for-sale state, including being configured to automatically notify one or more other participants of the respective property being offered for sale, and
wherein, after moving the selected property, the real-estate portfolio includes at least the selected property in the for-sale state, and one or more other properties in the hold state.

6. A facilitator arrangement according to claim 5, wherein the processor is further configured to provide to the participant, a home page including the respective real-estate portfolio, the home page being provided for display by the participant to manage the respective real-estate portfolio, the home page including a portion identifying one or more properties of the respective portfolio in the hold state, and a portion identifying one or more properties of the respective portfolio in the for-sale state, and
wherein the processor is configured to receive selection of the property via the home page.

7. A facilitator arrangement according to claim 5, wherein the processor is further configured to notify the participant of one or more properties of one or more other participants being offered for sale, the participant being automatically notified in response to (a) receiving selection of one or more properties in the hold state, and (b) moving the respective one or more properties from the hold state to the for-sale state.

8. A facilitator arrangement according to claim 7, wherein the processor is further configured to provide to the participant, a home page including the respective real-estate portfolio, the home page being provided for display by the participant to manage the respective real-estate portfolio, the home page including a portion identifying properties of the respective portfolio in the hold state, a portion identifying one or more properties of the respective portfolio in the for-sale state, and a portion identifying one or more properties of one or more other participants in the for-sale state, and
wherein the processor is configured to notify the participant via the home page.

9. A facilitator arrangement according to claim 5, wherein the processor is further configured to receive, from another participant, selection of a property of the participant in the for-sale state, the respective property being a for-sale property of the participant,
wherein the processor is configured to move the selected for-sale property from the for-sale state to an engaged state at least partially in response to receiving selection of the for-sale property,
wherein the processor is configured to engage, for an engagement period, the participant and the other participant in communication regarding the selected for-sale property,
wherein the processor is configured to restrict communication between one or both of the participant and the other participant, and further participants, during the engagement period, the processor being configured to restrict communication including restricting further participants from accessing or removing, from information available to further participants, at least some information for the selected for-sale property, and
wherein the processor is configured to move the selected for-sale property, engage the participant and other participant, and restrict communication at least partially in response to receiving selection of the property from the other participant.

10. A facilitator arrangement according to claim 5, wherein the information associated with a real-estate portfolio of the participant includes asset base criteria for the plurality of properties of the participant, the asset base criteria characterizing the respective properties,
wherein the processor is further configured to receive acquisition criteria for one or more properties one or more other participants anticipate purchasing, the acquisition criteria characterizing the respective one or more properties the one or more other participants anticipating purchasing,
wherein the processor is configured provide, to the participant, a number of properties the one or more other participants anticipate purchasing that have acquisition criteria matching the asset base criteria of the properties of the participant, and
wherein the processor is configured provide the number of properties for display by the participant, the number of properties being displayed as a measure of demand for the one or more properties of the participant.

11. A facilitator arrangement according to claim 10, wherein the processor is further configured to receive an adjustment of the asset base criteria for a property of the participant, and
wherein the processor being configured to provide the number of properties includes the processor being configured to update the number of properties provided to the participant.

12. A facilitator arrangement according to claim 11, wherein the asset base criteria include a plurality of criteria selected from the group consisting of property type, region, price range and capitalization rate.

13. A facilitator arrangement according to claim 10, wherein the processor being configured to provide the number of properties includes the processor being configured to provide a number of properties for one or more properties of the participant in the hold state, and for one or more of the properties of the participant in the for-sale state.

14. A method comprising:
receiving, and storing in a computer-readable storage medium, asset base criteria for one or more properties of a participant, the asset base criteria characterizing the respective one or more properties of the participant;
receiving, and storing in a computer-readable storage medium, acquisition criteria for one or more properties one or more other participants anticipate purchasing, the acquisition criteria characterizing the respective one or more properties the one or more other participants anticipating purchasing;
providing, to the participant, a number of properties the one or more other participants anticipate purchasing that have acquisition criteria matching the asset base criteria of the respective one or more properties of the participant,
wherein providing the number of properties comprises providing the number of properties for display by the participant, the number of properties being displayed as a measure of demand for the one or more properties of the participant.

15. A method according to claim 14 further comprising:
receiving asset base criteria for one or more properties of one or more other participants; and
providing, to the participant, a second number of properties of one or more other participants that have asset base criteria matching the asset base criteria of the respective one or more properties of the participant,
wherein providing the second number of properties comprises providing the second number of properties for display by the participant, the second number of properties being displayed as a measure of supply of one or more properties.

16. A method according to claim 14 further comprising:
receiving an adjustment of the asset base criteria for a property of the participant,
wherein providing the number of properties includes updating the number of properties provided to the participant.

17. A method according to claim 16, wherein the asset base criteria include a plurality of criteria selected from the group consisting of property type, region, price range and capitalization rate.

18. A method comprising:
maintaining a database including information associated with a real-estate portfolio of a participant, the real-estate portfolio including a plurality of properties of the participate, the properties initially being in a hold state in the database;
receiving selection of a property in the portfolio for offering the respective property for sale;
moving the selected property from the hold state to a for-sale state, moving the selected property including automatically notifying one or more other participants of the respective property being offered for sale,
wherein, after moving the selected property, the real-estate portfolio includes at least the selected property in the for-sale state, and one or more other properties in the hold state.

19. A method according to claim 18 further comprising:
providing to the participant, a home page including the respective real-estate portfolio, the home page being provided for display by the participant to manage the respective real-estate portfolio, the home page including a portion identifying one or more properties of the respective portfolio in the hold state, and a portion identifying one or more properties of the respective portfolio in the for-sale state,
wherein receiving selection of the property comprises receiving selection of the property via the home page.

20. A method according to claim 18 further comprising:
notifying the participant of one or more properties of one or more other participants being offered for sale, the participant being automatically notified in response to (a) receiving selection of one or more properties in the hold state, and (b) moving the respective one or more properties from the hold state to the for-sale state.

21. A method according to claim 20 further comprising:
providing to the participant, a home page including the respective real-estate portfolio, the home page being provided for display by the participant to manage the respective real-estate portfolio, the home page including a portion identifying properties of the respective portfolio in the hold state, a portion identifying one or more properties of the respective portfolio in the for-sale state, and a portion identifying one or more properties of one or more other participants in the for-sale state,
wherein notifying the participant comprises notifying the participant via the home page.

22. A method according to claim 18 further comprising:
receiving, from another participant, selection of a property of the participant in the for-sale state, the respective property being a for-sale property of the participant; and at least partially in response thereto,
moving the selected for-sale property from the for-sale state to an engaged state at least partially in response to receiving selection of the for-sale property;
engaging, for an engagement period, the participant and the other participant in communication regarding the selected for-sale property; and
restricting communication between one or both of the participant and the other participant, and further participants, during the engagement period, restricting communication comprising restricting further participants from accessing or removing, from information available to further participants, at least some information for the selected for-sale property.

23. A method according to claim 18, wherein the information associated with a real-estate portfolio of the participant includes asset base criteria for the plurality of properties of the participant, the asset base criteria characterizing the respective properties, and wherein the method further comprises:
receiving acquisition criteria for one or more properties one or more other participants anticipate purchasing, the acquisition criteria characterizing the respective one or more properties the one or more other participants anticipating purchasing;
providing, to the participant, a number of properties the one or more other participants anticipate purchasing that have acquisition criteria matching the asset base criteria of the properties of the participant,
wherein providing the number of properties comprises providing the number of properties for display by the participant, the number of properties being displayed as a measure of demand for the one or more properties of the participant.

24. A method according to claim 23 further comprising:
receiving an adjustment of the asset base criteria for a property of the participant,
wherein providing the number of properties includes updating the number of properties provided to the participant.

25. A method according to claim 24, wherein the asset base criteria include a plurality of criteria selected from the group consisting of property type, region, price range and capitalization rate.

26. A method according to claim 23, wherein providing the number of properties includes providing a number of properties for one or more properties of the participant in the hold state, and for one or more of the properties of the participant in the for-sale state.

27. A computer-program product comprising at least one computer-readable storage medium having computer-readable program code portions stored therein, the computer-readable program code portions comprising:
a first executable portion configured to receive and store asset base criteria for one or more properties of a participant, the asset base criteria characterizing the respective one or more properties of the participant;
a second executable portion configured to receive and store acquisition criteria for one or more properties one or more other participants anticipate purchasing, the acquisition criteria characterizing the respective one or more properties the one or more other participants anticipating purchasing; and
a third executable portion configured to provide, to the participant, a number of properties the one or more other participants anticipate purchasing that have acquisition criteria matching the asset base criteria of the respective one or more properties of the participant,
wherein the third executable portion is configured to provide the number of properties for display by the participant, the number of properties being displayed as a measure of demand for the one or more properties of the participant.

28. A computer-program product according to claim 27 further comprising:
a fourth executable portion configured to receive asset base criteria for one or more properties of one or more other participants; and
a fifth executable portion configured to provide, to the participant, a second number of properties of one or more other participants that have asset base criteria matching the asset base criteria of the respective one or more properties of the participant,
wherein the fifth executable portion is configured to provide the second number of properties for display by the participant, the second number of properties being displayed as a measure of supply of one or more properties.

29. A computer-program product according to claim 27 further comprising:
a fourth executable portion configured to receive an adjustment of the asset base criteria for a property of the participant,
wherein the third executable portion being configured to provide the number of properties includes the third executable portion being configured to update the number of properties provided to the participant.

30. A computer-program product according to claim 29, wherein the asset base criteria include a plurality of criteria selected from the group consisting of property type, region, price range and capitalization rate.

31. A computer-program product comprising at least one computer-readable storage medium having computer-readable program code portions stored therein, the computer-readable program code portions comprising:
a first executable portion configured to maintain a database including information associated with a real-estate portfolio of a participant, the real-estate portfolio including a plurality of properties of the participate, the properties initially being in a hold state in the database;
a second executable portion configured to receive selection of a property in the portfolio for offering the respective property for sale; and
a third executable portion configured to move the selected property from the hold state to a for-sale state, including being configured to automatically notify one or more other participants of the respective property being offered for sale,
wherein, after moving the selected property, the real-estate portfolio includes at least the selected property in the for-sale state, and one or more other properties in the hold state.

32. A computer-program product according to claim 31 further comprising:
a fourth executable portion configured to provide to the participant, a home page including the respective real-estate portfolio, the home page being provided for display by the participant to manage the respective real-estate portfolio, the home page including a portion identifying one or more properties of the respective portfolio in the hold state, and a portion identifying one or more properties of the respective portfolio in the for-sale state,
wherein the second executable portion is configured to receive selection of the property via the home page.

33. A computer-program product according to claim 31 further comprising:
a fourth executable portion configured to notify the participant of one or more properties of one or more other participants being offered for sale, the participant being automatically notified in response to (a) receiving selection of one or more properties in the hold state, and (b) moving the respective one or more properties from the hold state to the for-sale state.

34. A computer-program product according to claim 33 further comprising:
a fifth executable portion configured to provide to the participant, a home page including the respective real-estate portfolio, the home page being provided for display by the participant to manage the respective real-estate portfolio, the home page including a portion identifying properties of the respective portfolio in the hold state, a portion identifying one or more properties of the respective portfolio in the for-sale state, and a portion identifying one or more properties of one or more other participants in the for-sale state,
wherein the fourth executable portion is configured to notify the participant via the home page.

35. A computer-program product according to claim 31 further comprising:
a fourth executable portion configured to receive, from another participant, selection of a property of the participant in the for-sale state, the respective property being a for-sale property of the participant;
a fifth executable portion configured to move the selected for-sale property from the for-sale state to an engaged state at least partially in response to receiving selection of the for-sale property;
a sixth executable portion configured to engage, for an engagement period, the participant and the other participant in communication regarding the selected for-sale property; and
a seventh executable portion configured to restrict communication between one or both of the participant and the other participant, and further participants, during the engagement period, the processor being configured to restrict communication including restricting further participants from accessing or removing, from information available to further participants, at least some information for the selected for-sale property,
wherein the fifth, sixth and seventh executable portions are configured to move the selected for-sale property, engage the participant and other participant, and restrict communication at least partially in response to the fourth executable portion receiving selection of the property from the other participant.

36. A computer-program product according to claim 31, wherein the information associated with a real-estate portfolio of the participant includes asset base criteria for the plurality of properties of the participant, the asset base criteria characterizing the respective properties, and wherein the computer program product further comprises:
a fourth executable portion configured to receive acquisition criteria for one or more properties one or more other participants anticipate purchasing, the acquisition criteria characterizing the respective one or more properties the one or more other participants anticipating purchasing; and
a fifth executable portion configured provide, to the participant, a number of properties the one or more other participants anticipate purchasing that have acquisition criteria matching the asset base criteria of the properties of the participant,
wherein the fifth executable portion is configured provide the number of properties for display by the participant, the number of properties being displayed as a measure of demand for the one or more properties of the participant.

37. A computer-program product according to claim 36 further comprising:
a sixth executable portion configured to receive an adjustment of the asset base criteria for a property of the participant,
wherein the fifth executable portion being configured to provide the number of properties includes the fifth executable portion being configured to update the number of properties provided to the participant.

38. A computer-program product according to claim 37, wherein the asset base criteria include a plurality of criteria selected from the group consisting of property type, region, price range and capitalization rate.

39. A computer-program product according to claim 36, wherein the fifth executable portion being configured to provide the number of properties includes the fifth executable portion being configured to provide a number of properties for one or more properties of the participant in the hold state, and for one or more of the properties of the participant in the for-sale state.
